(19) United States
(12) Patent Application Publication
(10) Pub. No.: US 2023/0168463 A1
(43) Pub. Date: Jun. 1, 2023

(54) OPTICAL ELEMENT, OPTICAL DEVICE, AND IMAGE PICKUP APPARATUS

(71) Applicant: CANON KABUSHIKI KAISHA, Tokyo (JP)

(72) Inventors: YASUHIRO TANAKA, Tokyo (JP); MAMO MATSUMOTO, Kanagawa (JP); TAKEAKI KUMAGAI, Tokyo (JP)

(21) Appl. No.: 18/054,967

(22) Filed: Nov. 14, 2022

(30) Foreign Application Priority Data
Nov. 26, 2021 (JP) 2021-192000
Nov. 26, 2021 (JP) 2021-192001

(51) Int. Cl. G02B 7/02; H04N 5/225

(52) U.S. Cl. CPC G02B 7/025; H04N 5/2254

(57) ABSTRACT

An optical element includes a first transparent member, a second transparent member disposed in contact with the first transparent member and having a different linear expansion coefficient from the first transparent member, and a bonding member configured to bond the first transparent member and the second transparent member to each other. An elastic modulus of the bonding member is 1700 MPa or less at a temperature of −30° C.

### BACKGROUND OF THE INVENTION

### Field of the Invention

The present disclosure relates to an optical element, optical device, and an image pickup apparatus.

### Description of the Related Art

Conventionally, in an optical system of an optical device, it is attempted to reduce the weight of the optical device by using a resin lens as a lens included in the optical system. The lens is preferably strongly fixed to a mounting member with a high positional precision without distorting the optical functional surface of the lens. As a method for attaching the lens to the mounting member, there is a method of attaching the lens to the mounting member by deforming the mounting member by heat caulking. In the case where the lens is a resin lens, the resin lens can be deformed during the heat caulking, and the deformation of the resin lens can cause deterioration of the optical performance of the resin lens. Japanese Patent Laid-Open No. 2018-72766 proposes a method of using a glass lens as the lens fixed to the mounting member by heat caulking and bonding a resin lens to the glass lens by using an adhesive or the like.

### SUMMARY OF THE INVENTION

According to a first aspect of the present invention, an optical element includes a first transparent member, a second transparent member disposed in contact with the first transparent member and having a different linear expansion coefficient from the first transparent member, and a bonding member configured to bond the first transparent member and the second transparent member to each other. An elastic modulus of the bonding member is 1700 MPa or less at a temperature of −30° C.

According to a second aspect of the present invention, an optical element includes a first transparent member, a second transparent member having a different linear expansion coefficient from the first transparent member, and a bonding member configured to bond the first transparent member and the second transparent member to each other. The first transparent member has a first main surface. The second transparent member has a second main surface that is partially in contact with the first main surface. The bonding member is separated from a position where the first main surface and the second main surface are in contact with each other.

Further features of the present invention will become apparent from the following description of exemplary embodiments with reference to the attached drawings.

### BRIEF DESCRIPTION OF THE DRAWINGS

FIG. 1 is an explanatory diagram illustrating a schematic configuration of a digital camera serving as an example of an image pickup apparatus according to a first embodiment.

FIG. 2A is a plan view of an optical unit according to the first embodiment.

FIG. 2B is a section view of the optical unit according to the first embodiment.

FIG. 2C is an enlarged section view of the optical unit according to the first embodiment.

FIG. 3 is a plan view of an optical unit according to a first comparative example.

FIG. 4A is an explanatory diagram of a step of a manufacturing method for an optical element according to the first embodiment.

FIG. 4B is an explanatory diagram of a step of the manufacturing method for the optical element according to the first embodiment.

FIG. 4C is an explanatory diagram of a step of the manufacturing method for the optical element according to the first embodiment.

FIG. 4D is an explanatory diagram of a step of the manufacturing method for the optical element according to the first embodiment.

FIG. 5A is an explanatory diagram of an optical unit of a first modification example.

FIG. 5B is an explanatory diagram of an optical unit of a second modification example.

FIG. 5C is an explanatory diagram of an optical unit of a third modification example.

FIG. 6 is a table showing conditions and results of Examples 1 to 7 and Comparative Example 1.

FIG. 7 is a graph showing results of Examples 1 to 7.

FIG. 8A is a plan view of an optical unit according to a second embodiment.

FIG. 8B is a section view of the optical unit according to the second embodiment.

FIG. 8C is an enlarged section view of the optical unit according to the second embodiment.

FIG. 9A is a plan view of an optical unit of a second modification example.

FIG. 9B is a section view of the optical unit of the second modification example.

FIG. 9C is an enlarged section view of the optical unit of the second modification example.

FIG. 10A is an explanatory diagram of a step of a manufacturing method for an optical element according to the second embodiment.

FIG. 10B is an explanatory diagram of a step of the manufacturing method for the optical element according to the second embodiment.

FIG. 10C is an explanatory diagram of a step of the manufacturing method for the optical element according to the second embodiment.

FIG. 10D is an explanatory diagram of a step of the manufacturing method for the optical element according to the second embodiment.

FIG. 11A is an explanatory diagram of an optical unit of a fourth modification example.

FIG. 11B is an explanatory diagram of an optical unit of a fifth modification example.

FIG. 12A is an explanatory diagram of an optical unit of a sixth modification example.

FIG. 12B is an explanatory diagram of the optical unit of the sixth modification example.

FIG. 13 is a table showing conditions and results of Examples 8 to 24 and Comparative Examples 2 and 3.

FIG. 14 is a table showing conditions of Examples 8 to 24 and Comparative Examples 2 and 3.

FIG. 15 is a table showing conditions of Examples 8 to 24 and Comparative Examples 2 and 3.

### DESCRIPTION OF THE EMBODIMENTS

In the description below, exemplary embodiments of the present disclosure will be described in detail with reference to drawings.

### First Embodiment

### Image Pickup Apparatus

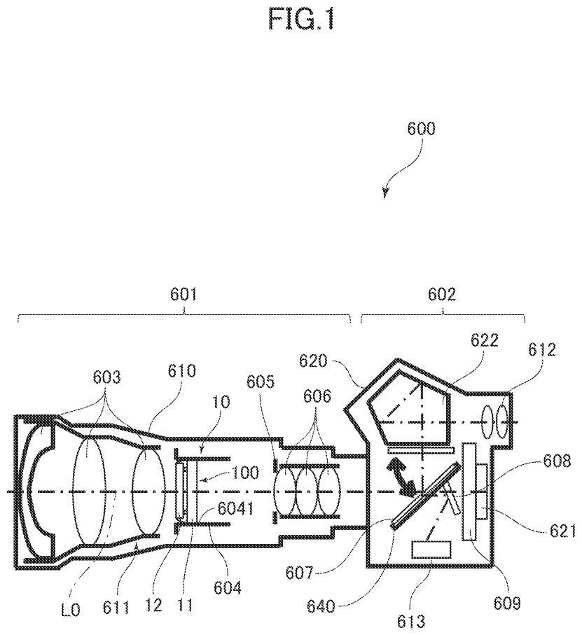

FIG. 1 is an explanatory diagram illustrating a schematic configuration of a digital camera 600 serving as an example of an image pickup apparatus according to a first embodiment. The digital camera 600 is, for example, a single reflex lens digital camera. The digital camera 600 includes a camera body 602 serving as an example of an image pickup apparatus body, and a lens barrel 601 serving as an example of an optical device. The lens barrel 601 is a replaceable lens that is attachable to and detachable from the camera body 602.

The lens barrel 601 includes a casing 610 and an optical system 611 disposed inside the casing 610. The optical system 611 is an image pickup optical system, and includes a plurality of lenses 603, an optical element 10, a diaphragm 605, and a plurality of lenses 606 that are disposed on an optical axis L0. Light from an object passes through the plurality of lenses 603, the optical element 10, the diaphragm 605, and the plurality of lenses 606, and is then received by an image sensor 621 of the camera body 602.

The optical element 10 includes an optical unit 100, and an inner barrel 604 supporting the optical unit 100. The optical unit 100 includes a lens 11 serving as an example of a first transparent member, and a lens 12 serving as an example of a second transparent member. Being transparent corresponds to a state in which transmittance of light in a wavelength range of 400 nm to 780 nm is 10% or more.

The lens 11 is held by the inner barrel 604, and the lens 12 is fixed to the lens 11. The inner barrel 604 serves as an example of a holding member. The inner barrel 604, that is, the optical element 10 is disposed inside the casing 610 so as to be movable in the direction of the optical axis L0 with respect to the casing 610 for focusing, zooming, or the like.

The camera body 602 includes a casing 620, and the image sensor 621 described above that is disposed inside the casing 620. The image sensor 621 is, for example, a complementary metal oxide semiconductor: CMOS image sensor, or a charge coupled device: CCD image sensor.

In an observation period before imaging, the light from the object having passed through the optical system 611 of the lens barrel 601 is reflected by a main mirror 607 in the casing 620 of the camera body 602. The reflection light passes through a prism 622 and thus the photographer can see a captured image through a finder lens 612. The main mirror 607 is, for example, a half mirror. Light having passed through the main mirror 607 is reflected by a sub mirror 608 toward an autofocus unit: AF unit 613. This reflection is used for, for example, distance measurement. In addition, the main mirror 607 is attached to a main mirror holder 640 by using an adhesive or the like, and is thus supported by the main mirror holder 640. At the time of imaging, in the case where the photographer presses an unillustrated shutter button, an unillustrated driving mechanism moves the main mirror 607 and the sub mirror 608 out of the optical path, and opens a shutter 609. As a result of this, light from the object having passed through the optical system 611 of the lens barrel 601, that is, a captured optical image is formed on the image sensor 621. As a result of this, a captured image can be obtained from the image sensor 621. To be noted, the diaphragm 605 is configured such that the brightness and focusing depth of the imaging can be changed by changing the aperture area thereof.

### Optical Unit

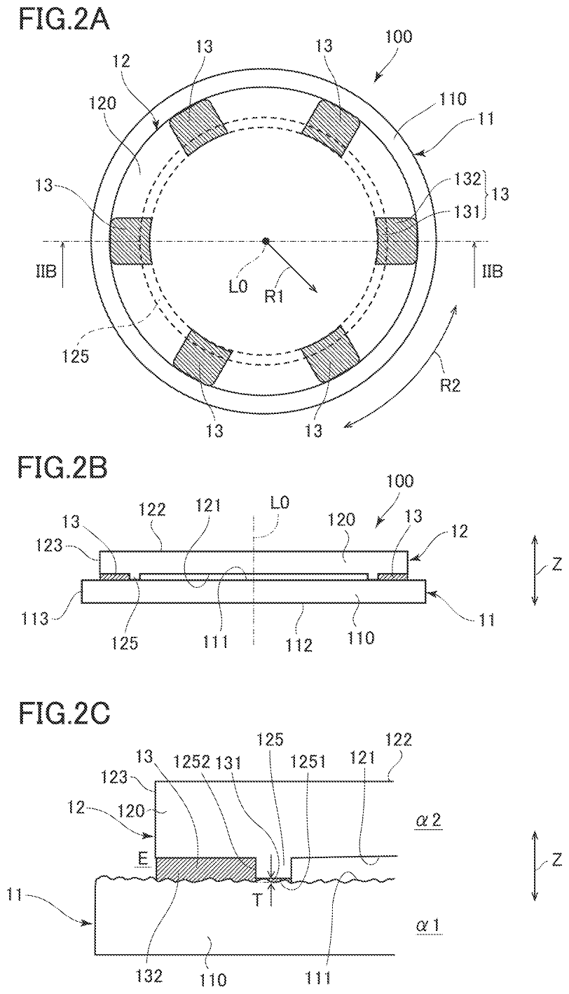

FIG. 2A is a plan view of the optical unit 100 according to the first embodiment. FIG. 2B is a section view of the optical unit 100 according to the first embodiment. FIG. 2C is an enlarged section view of the optical unit 100 according to the first embodiment. FIG. 2B illustrates a cross-section of the optical unit 100 taken along a line IIB-IIB of FIG. 2A. FIG. 2C illustrates part of FIG. 2B in an enlarged form.

As described above, the optical unit 100 includes the lens 11 and the lens 12. The lens 11 and the lens 12 are disposed in contact with each other in a state in which the center axis of the lens 11 and the center axis of the lens 12 coincide with each other.

The lenses 11 and 12 each have a circular outer shape as viewed in the direction of the optical axis L0. The optical axis L0 also serves as a center axis that pass through the center of each of the lenses 11 and 12. The lens 11 is larger than the lens 12 as viewed in the direction of the optical axis L0. That is, the lens 11 has a larger diameter than the lens 12. In the description below, the direction of the optical axis L0 will be referred to as a Z direction. In addition, a direction orthogonal to the optical axis L0 and extending from the optical axis L0 will be referred to as a radial direction R1. In addition, a direction about the optical axis L0 centered on the optical axis L0 will be referred to as a peripheral direction R2.

The lens 11 includes a main surface 111 serving as a first main surface, a main surface 112 on the back side of the main surface 111, and an outer peripheral surface 113. The lens 12 includes a main surface 121 serving as a second main surface, a main surface 122 on the back side of the main surface 121, and an outer peripheral surface 123. Part or entirety of each of the main surfaces 111, 112, 121, and 122 is used as an optical functional surface.

The main surface 121 is separated from the main surface 111 in the Z direction and faces the main surface 111. That is, there is a distance between the main surfaces 111 and 121. The shape of each of the main surfaces 111, 112, 121, and 122 is not limited, and one of shapes such as a concave spherical surface, a convex spherical surface, an axially-symmetrical aspherical surface, and a flat surface is preferable.

The lens 11 is fixed to an inner wall 6041 of the inner barrel 604 illustrated in FIG. 1. In the first embodiment, the inner barrel 604 is formed of resin. The lens 11 is fixed to the inner barrel 604 by heat caulking.

The lens 12 includes a projection portion 125 projecting with respect to the main surface 121. The projection portion 125 projects toward the main surface 111 of the lens 11. In the first embodiment, the projection portion 125 is formed in an annular shape as viewed in the Z direction. The projection portion 125 is provided for positioning the main surface 121 in a predetermined distance from the main surface 111, and is provided in contact with the main surface 111. As a result of this, the lens 12 is positioned with high precision with respect to the lens 11 such that the main surface 121 is provided in a predetermined distance from the main surface 111 in the Z direction.

The optical unit 100 includes at least one bonding member formed from an adhesive. In the first embodiment, the optical unit 100 includes a plurality of, for example, six bonding members 13. The lenses 11 and 12 are bonded together via the plurality of bonding members 13. In the first embodiment, the lens 12 is glued and fixed to the lens 11 via the plurality of bonding members 13. The plurality of bonding members 13 are arranged at intervals in the peripheral direction R2. In the first embodiment, the plurality of bonding members 13 are arranged in the peripheral direction R2 at equal intervals, for example, at an interval of 60° each about the optical axis L0. Each of the bonding members 13 is partially or entirely disposed between the lenses 11 and 12. In the first embodiment, the bonding members 13 are entirely disposed between the lenses 11 and 12. Further, the bonding members 13 are each disposed in contact with the main surfaces 111 and 121.

The projection portion 125 includes an end surface 1251 that is a distal end surface. The end surface 1251 faces the main surface 111, and is partially in contact with the main surface 111. That is, the end surface 1251 and/or the main surface 111 are rough surfaces, and therefore the end surface 1251 is partially in contact with the main surface 111. Specifically, at least one of the main surface 111 and the end surface 1251 is not a smooth surface, and is a surface that is uneven in a micrometer order or a sub-micrometer order. In the example of FIG. 2C, the main surface 111 is a rough surface. Therefore, the end surface 1251 is partially in contact with the main surface 111, and there is a small gap between the main surface 111 and the end surface 1251 in a portion where these two are not in contact with each other. At least part of each of the bonding members 13 is present between the main surface 111 and the end surface 1251.

The bonding members 13 each include a bonding portion (fixing portion) 131 present in the gap between the main surface 111 and the end surface 1251, and a bonding portion (fixing portion) 132 that is in contact with the main surfaces 111 and 121 and an outer side surface 1252 of the projection portion 125. The bonding portions 131 and 132 are continuously and integrally formed. That is, the bonding portions 131 and 132 are in contact with each other. The bonding portion 132 is positioned more on the outside than the bonding portion 131 in the radial direction R1. In addition, the volume of the bonding portion 132 is larger than the volume of the bonding portion 131. The bonding member 13 is a cured product of the adhesive, and the adhesive includes uncured resin. The bonding member 13 includes a cured product of the resin.

The lens 11 includes a substrate 110 serving as an example of a first transparent substrate. The substrate 110 is a lens body. The lens 11 may include a functional film formed on the surface of the substrate 110. The functional film is constituted by at least one functional layer. The functional layer is a coating layer, and examples thereof include an antireflection layer, a hydrophilic layer, and the like. For example, the antireflection layer is formed from a paint including particles of a size in a micrometer order. For example, the hydrophilic layer includes Sift.

The lens 12 includes a substrate 120 serving as an example of a second transparent substrate. The substrate 120 is a lens body. The lens 12 may include a functional film formed on the surface of the substrate 120. The functional film is constituted by at least one functional layer. The functional layer is a coating layer, and examples thereof include an antireflection layer, a hydrophilic layer, and the like. For example, the hydrophilic layer includes SiO₂.

The material of the substrate 110 is glass such as optical glass. The glass can be selected from silicate glass, borosilicate glass, phosphate glass, quartz glass, glass ceramics, and the like.

The material of the substrate 120 is different from the material of the substrate 110, and is resin in the first embodiment. The resin is preferably optical resin. The optical resin can be selected from cycloolefin polymer, acrylic resin, polyester resin, polycarbonate, and the like.

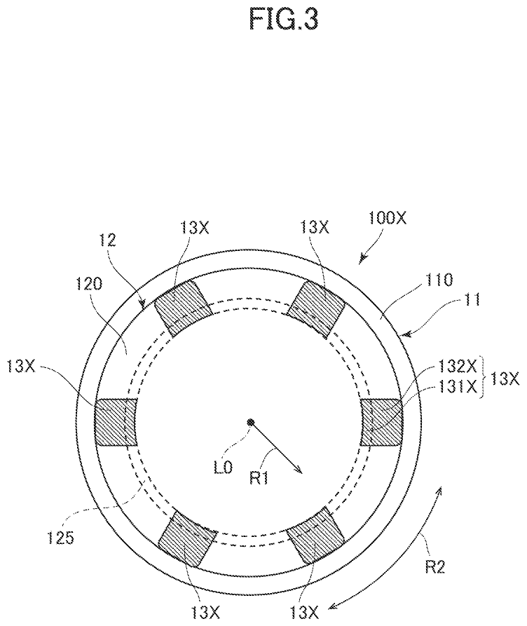

Here, an optical unit of a first comparative example will be described. To be noted, in the description below, the lens 11 will be also referred to as a glass lens, and the lens 12 will be also referred to as a resin lens. FIG. 3 is a plan view of an optical unit 100X of the first comparative example. The optical unit 100X of the first comparative example includes the lenses 11 and 12 similarly to the first embodiment. The optical unit 100X of the first comparative example includes a plurality of bonding members 13X formed from a material different from the material constituting the bonding members 13. The bonding members 13X are each formed from an adhesive. The bonding members 13X each include bonding portions 131X and 132X. The bonding portion 131X is disposed at the same position as the bonding portion 131. The bonding portion 132X is disposed at the same position as the bonding portion 132.

When an optical device including the optical unit 100X of the first comparative example is used in a low-temperature environment and then is returned from the low-temperature environment to a room-temperature environment, a phenomenon of the lens 12 relatively displacing, that is, becoming eccentric with respect to the lens 11 occurs in some cases. As described above, there is a possibility that the fixed position of the lens 12 with respect to the lens 11 is changed and the image pickup performance deteriorates.

Therefore, the present inventors observed the optical unit 100X, and as a result, confirmed that the bonding portions 131X included in some of the plurality of bonding members 13X were partially or entirely peeled off from the projection portion 125 or the lens 11. For example, this is a phenomenon in which the bonding portion 131X is partially or entirely peeled off in each of four bonding members 13X among the six bonding members 13X. The present inventors considered that, as a result of occurrence of such interface delamination, an imbalance in the adhesive force occurs between the bonding members 13X, and the lens 12 becomes eccentric with respect to the lens 11 when the optical unit 100X returns from the low-temperature environment to the room-temperature environment.

The present inventors reached the following idea on the cause of occurrence of such interface delamination. That is, the material of the substrate 120 is different from the material of the substrate 110. Since the material of the substrate 120 is different from the material of the substrate 110, the linear expansion coefficient of the substrate 120 is different from the linear expansion coefficient of the substrate 110. That is, the linear expansion coefficient of the substrate 110 formed of glass is smaller than the linear expansion coefficient of the substrate 120 formed of resin. In the case where the temperature of the environment in which the optical unit 100X is put changes from a room temperature to a low temperature, the thermal contraction amount in the radial direction R1 is larger for the lens 12 including the substrate 120 formed of resin than the lens 11 including the substrate 110 formed of glass. Here, the room temperature is a normal temperature, for example, 23° C.±2° C. In addition, the low temperature is below the freezing point. In the case where the optical device is used in the low-temperature environment, thermal stress is generated in each of the bonding members 13X due to the difference between the thermal contraction amount of the lens 11 and the thermal contraction amount of the lens 12. Therefore, it can be considered that the interface delamination occurred in the bonding portions 131X of the bonding members 13X due to the occurrence of the thermal stress in the bonding portions 131X of the bonding members 13X.

Therefore, the present inventors found that the peeling of the bonding members 13 can be reduced by adjusting the elastic modulus E of each of the bonding members 13 in the low-temperature environment to be low. That is, the elastic modulus E of each of the bonding members 13 of the first embodiment is 1700 MPa or less at the temperature of −30° C. Here, −30° C. includes a tolerance of ±0.5° C. In addition, in the first embodiment, the elastic modulus E is storage elastic modulus. To be noted, micro-indentation hardness tester including a nanoindenter can be used for the measurement of the elastic modulus E of the bonding members 13 at the temperature of −30° C.

According to the first embodiment, by imparting flexibility to the bonding members 13 in the low-temperature environment, the bonding members 13 can be caused to follow the difference in the thermal contraction amount between the lenses 11 and 12, and thus the thermal stress generated in the bonding portions 131 of the bonding members 13 can be relieved. As a result of this, the interface delamination in the bonding portions 131 of the bonding members 13 can be suppressed. Therefore, even when the optical element 10 is exposed to the low-temperature environment and then the temperature of the environment in which the optical element 10 is put is changed from the low temperature to the room temperature, the balance of the adhesive force in the bonding members 13 can be maintained, and thus the relative displacement of the lens 12 with respect to the lens 11, that is, eccentricity can be reduced. Focusing on the lens 12 as a standard, the relative displacement of the lens 11 with respect to the lens 12 can be reduced.

In addition, since the plurality of bonding members 13 are arranged at equal intervals in the peripheral direction R2, the stress generated in the bonding members 13 by the thermal contraction of the lenses 11 and 12 is equalized, and thus the displacement of the lens 12 with respect to the lens 11 is reduced.

Here, even if the lens 11 includes a functional film, since most part of the lens 11 is the substrate 110, the thermal contraction of the substrate 110 can be regarded as the thermal contraction of the lens 11. In addition, even if the lens 12 includes a functional film, since most part of the lens 12 is the substrate 120, the thermal contraction of the substrate 120 can be regarded as the thermal contraction of the lens 12.

The elastic modulus E of each of the bonding members 13 is preferably 200 MPa or more at the temperature of −30° C. That is, the force required for peeling the lens 12 off from the lens 11 is preferably 40 N or more. As a result of this, the lenses 11 and 12 are strongly fixed to each other via the bonding members 13. To be noted, the force required for peeling the lens 12 off from the lens 11 is equal to the force required for peeling the lens 11 off from the lens 12. In the description below, these forces will be referred to as “delamination force”.

As described above, in the low-temperature environment, as a result of the elastic modulus E of each of the bonding members 13 being 200 MPa to 1700 MPa, the relative displacement between the lenses 11 and 12 can be reduced, and the delamination force can be increased. From the above-described viewpoint, the elastic modulus E of each of the bonding members 13 is more preferably 400 MPa to 1400 MPa at the temperature of −30° C.

A measurement method for the delamination force will be described. First, the lens 12 is held such that the outer peripheral surface 123 of the lens 12 is pressed inwardly in the radial direction R1 at three points arranged at an interval of 120° each in an environment of a temperature range from −10° C. to 0° C. Then, the entirety of the lens 11 is lifted with respect to the lens 12 by using a push-pull gauge. Specifically, the lens 11 is lifted in the normal direction with respect to the center of the optical surface. The maximum load by which the plurality of bonding members 13 are peeled off from the lens 12 at this time is referred to as the delamination force.

In addition, a hydrophilic layer formed of Sift or the like may be used as a functional film formed on the surface of each of the substrates 110 and 120 or an outer layer on the functional film. As a result of this, the tightness of adhesion of the bonding portion 131 at the bonding interface can be improved, and thus peeling of the bonding portion 131 can be effectively reduced. In addition, surface modification such as chemically bonding a carbonyl group, a carboxyl group, or the like to the surface by plasma treatment in atmospheric pressure or UV ozone treatment may be performed on the surface of each of the lenses 11 and 12. As a result of this, the tightness of adhesion of the bonding portion 131 at the bonding interface can be improved, and peeling of the bonding portion 131 can be effectively reduced.

Here, the linear expansion coefficient of the substrate 110 is denoted by al, and the linear expansion coefficient of the substrate 120 is denoted by α2. The elastic modulus E of the bonding members 13 described above is more effective in the case where α1/α2≤0.24 is satisfied. That is, even in the case where there is a big difference between the linear expansion coefficients α1 and α2 satisfying α1/α2≤0.24, the thermal stress generated in each of the bonding members 13 can be effectively relieved, and peeling of the bonding portions 131 can be effectively reduced. Therefore, relative displacement of the lens 12 with respect to the lens 11, that is, eccentricity can be effectively reduced.

To be noted, the size relationship between the lenses 11 and 12 is not limited to the relationship described above. In addition, as the radius of the lens 12 including the substrate 120 formed of resin increases, the contraction amount of the lens 12 in the radial direction R1 at a low temperature increases. Therefore, the thermal stress generated in the bonding members 13 also increases, but since the bonding members 13 each have the configuration described above, the eccentricity of the lens 12 with respect to the lens 11 can be reduced.

In addition, the average thickness T of the bonding portion 131 in the Z direction is preferably 0.05 mm or less. In the low-temperature environment, the bonding members 13 can effectively follow the relative contraction in the radial direction R1 of the lens 12 with respect to the lens 11 caused by the difference in the linear expansion coefficient between the substrates 110 and 120. For a similar reason, the average thickness T of the bonding portions 131 in the Z direction is preferably 0.01 mm or more. That is, the average thickness T of the bonding portions 131 in the Z direction is preferably 0.01 mm to 0.05 mm.

The measurement method for the thickness of the bonding portion 131 will be described. First, the lens 12 is held such that the outer peripheral surface 123 of the lens 12 is pressed inwardly in the radial direction R1 at three points arranged at an interval of 120° each in an environment of a temperature range from −10° C. to 0° C. Then, the entirety of the lens 11 is lifted with respect to the lens 12. Specifically, the lens 11 is lifted in the normal direction with respect to the center of the optical surface. As a result of this, the bonding members 13 are peeled off from the lens 12 while still sticking to the lens 11. The film thickness of the bonding portions 131 of the bonding members 13 is measured at three positions by a film thickness meter, and the average value of the three measured values is used as the average thickness T.

Next, the adhesive used for forming the bonding members 13 will be described. The bonding members 13 are cured products of the adhesive, and the adhesive includes uncured resin. The bonding members 13 include cured products of resin. The bonding members 13 are each preferably a cured product of a cross-linking adhesive. That is, the adhesive is preferably a cross-linking adhesive. As the cross-linking adhesive, for example, a photocurable adhesive such as a UV-curable adhesive containing UV-curable resin, a heat-curable adhesive, or a moisture-curable adhesive can be used. Among these kinds of adhesives, the photocurable adhesive is more preferable. Among photocurable adhesives, UV-curable adhesives are more preferable. The UV-curable adhesive can be instantly cured by being irradiated with UV light. Therefore, the operability in the application and the adhesivity can be improved.

In addition, in the case where the elastic modulus of each of the bonding members 13 at the temperature of −30° C. is denoted by E [MPa] and the average thickness of the bonding portion 131 of each of the bonding members 13 is denoted by T [mm], it is preferable that E≤3.5×10⁴×T−50 is satisfied.

### Manufacturing Method for Optical Element

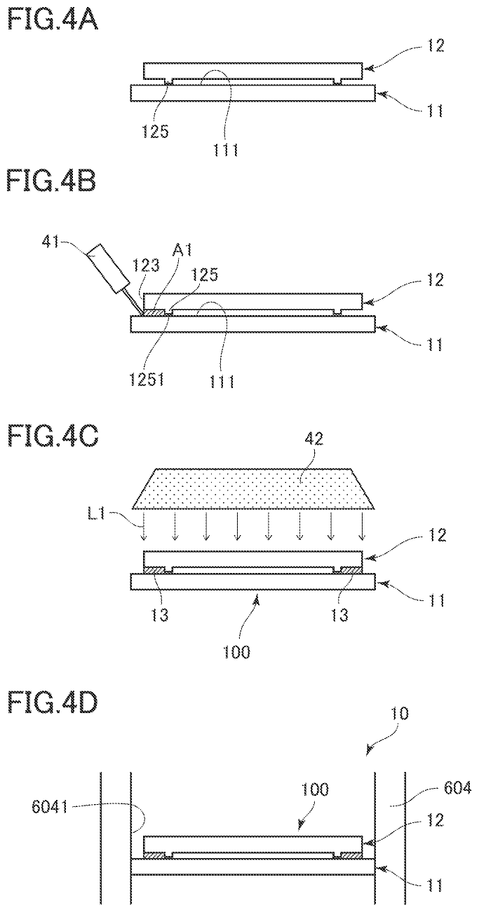

A manufacturing method for the optical element 10 will be described. FIGS. 4A to 4D are explanatory diagrams of respective steps of the manufacturing method for the optical element 10 according to the first embodiment.

First, as illustrated in FIG. 4A, the lenses 11 and 12 are prepared, and the lenses 11 and 12 are brought into contact with each other. Specifically, the projection portion 125 of the lens 12 is brought into contact with the main surface 111 of the lens 11. At this time, the positions are adjusted such that the center axis of the lens 11 and the center axis of the lens 12 coincide with each other.

Then, as illustrated in FIG. 4B, an adhesive A1 is supplied to the gap between the lenses 11 and 12. For the supply of the adhesive A1, a publicly known method with which the adhesive A1 can be discharged by a constant amount is used. For example, the adhesive A1 is applied to the gap between the lenses 11 and 12 from the vicinity of the outer peripheral surface 123 of the lens 12 by using an air dispenser 41 or the like. In the first embodiment, the adhesive A1 is applied on six positions at equal intervals in the peripheral direction R2 illustrated in FIG. 2A.

When the adhesive A1 is applied on each position, the adhesive A1 at each position wet-spreads between the lenses 11 and 12, and reaches a gap between the end surface 1251 of the projection portion 125 and the main surface 111. Further, the adhesive A1 permeates to the gap therebetween by the capillary action, and thus the gap is filled with the adhesive.

The viscosity of the adhesive A1 is not limited, but is preferably less than 3000 mPas. In the case where the viscosity of the adhesive A1 is less than 3000 mPas, the adhesive A1 easily wet-spreads, and thus the adhesive A1 easily permeates between the end surface 1251 of the projection portion 125 and the main surface 111. To be noted, a protrusion having a height of 0.05 mm or less may be provided on the end surface 1251 in advance to control the thickness of the bonding portions 131 that are to be formed.

Then, the adhesive A1 is cured. The adhesive A1 is, for example, a UV-curable adhesive. As illustrated in FIG. 4C, the adhesive A1 is cured by irradiating the adhesive A1 with UV light L1 from a light source 42. For example, a high-pressure mercury lamp, a light-emitting diode irradiator: LED irradiator, or the like can be used as the light source 42. By curing the adhesive A1, the bonding members 13 fixing the lens 12 to the lens 11 are formed. The elastic modulus E of the bonding members 13 is 1700 MPa or less at the temperature of −30° C. In this manner, the lenses 11 and 12 are bonded via the bonding members 13, and thus the optical unit 100 is obtained.

To be noted, the obtained optical unit 100 may be subjected to annealing treatment. By performing the annealing treatment, the out gas generated from the cured product of the adhesive can be reduced, and the adhesive force of the bonding members 13 can be made stronger.

Then, as illustrated in FIG. 4D, the optical unit 100 is disposed inside the inner barrel 604, part of the inner wall 6041 of the inner barrel 604 is subjected to heat caulking, and thus the lens 11 is fixed to the inner wall 6041 of the inner barrel 604. The optical element 10 is obtained by the steps described above.

To be noted, the order of the steps is not limited to this. For example, the lens 12 may be glued and fixed to the lens 11 after fixing the lens 11 to the inner barrel 604 by heat caulking.

In addition, the number of the bonding members 13 is not limited to 6, and may be 2 or more, such as 3.

### Modification Examples of First Embodiment

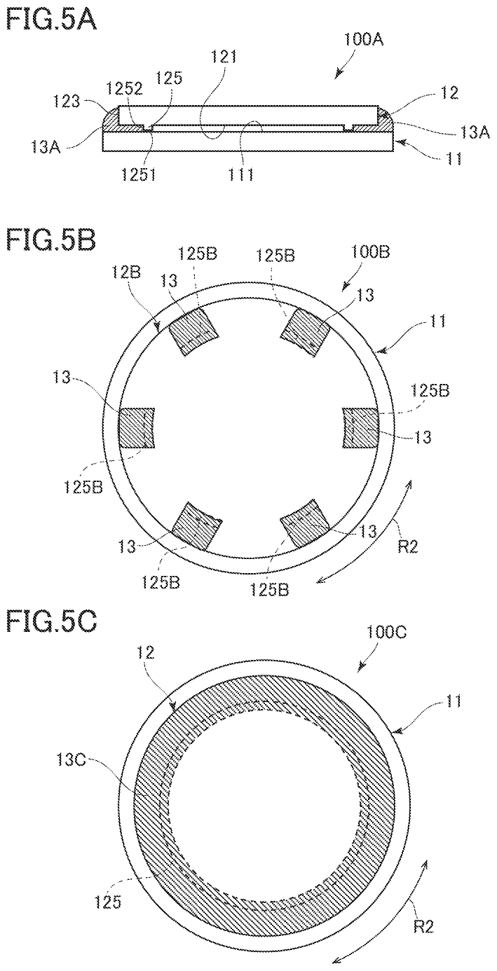

Modification examples of the first embodiment will be described. FIGS. 5A to 5C are explanatory diagrams of optical units of modification examples. FIG. 5A illustrates an optical unit 100A of a first modification example, FIG. 5B illustrates an optical unit 100B of a second modification example, and FIG. 5C illustrates an optical unit 100C of a third modification example. To be noted, in the lens barrel 601 of the first embodiment described above, one of the optical units 100A to 100C is used in place of the optical unit 100.

As illustrated in FIG. 5A, the optical unit 100A includes a plurality of bonding members 13A instead of the plurality of bonding members 13. The bonding members 13A may each be in contact with the main surface 111 of the lens 11, the main surface 121 of the lens 12, and the outer peripheral surface 123 of the lens 12. When manufacturing the optical unit 100A, the adhesive may be applied to flow out of the lens 12. Since the bonding members 13A are in contact with the outer peripheral surface 123 of the lens 12, the lens 12 can be more strongly fixed to the lens 11. Therefore, eccentricity of the lens 12 with respect to the lens 11 can be more effectively reduced when the optical element, that is, the digital camera is used in a low-temperature environment.

In addition, as illustrated in FIG. 5B, a lens 12B serving as an example of a second transparent member may include a plurality of projection portions 152B arranged at intervals in the peripheral direction R2. The projection portions 152B are each disposed to be in contact with corresponding one of the plurality of bonding members 13.

In addition, as illustrated in FIG. 5C, one bonding member 13C may be disposed to surround the projection portion 125. When manufacturing the optical unit 100C, the adhesive may be applied between the lenses 11 and 12 for the entirety in the peripheral direction R2.

### EXAMPLES

Examples 1 to 7 corresponding to the first embodiment described above and Comparative Example 1 corresponding to the first comparative example described above will be described below as results of experiments.

### Example 1

A manufacturing process of the optical unit 100 will be described. The lenses 11 and 12 each do not include the functional film, and are respectively constituted by the substrates 110 and 120. As the lens 11, a glass lens formed from optical glass S-FPL53 manufactured by OHARA INC. was prepared. The glass lens was a lens which had a diameter of 35 mm, whose R1 surface was a flat surface, and whose R2 surface was a concave spherical surface. The curvature radius R of the concave spherical surface was 190 mm.

As the lens 12, a resin lens formed from resin ZEONEX E48R manufactured by Zeon Corporation was prepared. The resin lens was a lens which had a diameter of 34 mm, whose R1 surface was an aspherical surface, and whose R2 surface was a flat surface. The projection portion 125 was formed in an annular shape having a height of 0.8 mm. The projection portion 125 was disposed at a position that is 2 mm inward from the outer peripheral surface 123 in the radial direction R1. The value of α1/α2 was 0.24.

The positions were adjusted such that the projection portion 125 of the lens 12 was in contact with the R1 surface of the lens 11, and the center axis of the lens 11 and the center axis of the lens 12 overlapped. The average thickness T of the bonding portions 131 was 0.01 mm.

As the adhesive, an acrylic UV adhesive CHEMISEAL U-1455N manufactured by CHEMITECH INC. was used. The elastic modulus E at −30° C. of the cured product obtained by curing this adhesive was 1030 MPa. A syringe container containing this adhesive was placed in an air pulse-type air dispenser SuperΣ CMIII manufactured by Musashi Engineering, Inc., and 2 mg each of the adhesive was applied on three positions arranged at an interval of 120° each between the lenses 11 and 12. After the elapse of 10 seconds since the last application of the adhesive, the entirety of the lenses 11 and 12 were irradiated with light of 50 mW for 300 seconds by an LED area irradiator having a light wavelength of 365 nm, and thus the optical unit 100 was obtained.

### Evaluation

The thickness of the bonding portions 131 was measured at three points by an optical interferometer IRMS8599B manufactured by CHINO CORPORATION, and the average value of the three points was calculated as the average thickness T. The elastic modulus E of the bonding members 13 at −30° C. was measured by using a micro-indentation hardness tester manufactured by Agilent Technology. As a result of observing the bonding members 13 from above with a microscope, part of the bonding members 13 was present between the end surface 1251 and the main surface 111 as the bonding portions 131.

The fixed position of the lens 12 with respect to the lens 11 was measured in advance at a normal temperature by an image measurement machine NEAIV VHZ-H3030 manufactured by NIKON CORPORATION. Then, the optical unit 100 was left to stand for 24 hours in a freezer whose inner temperature was −30° C. Thereafter, the optical unit 100 was taken out from the freezer and returned to the normal temperature, and then the fixed position of the lens 12 with respect to the lens 11 was measured by the above-described image measurement machine in a similar manner. Then, the change in the fixed position of the lens 12 with respect to the lens 11 was calculated.

A case where the change in the fixed position of the lens 12 with respect to the lens 11 was less than 10 μm was evaluated as “A”, and a case where the change in the fixed position was equal to or more than 10 μm was evaluated as “B”. In addition, the delamination force of the lenses 11 and 12 was measured by applying a load on the lens 12 from the side by a push-pull gauge manufactured by IMADA CO., LTD. A case where the maximum load by which the lenses were delaminated was 40 N or more was evaluated as “A”, and a case where the maximum load was less than 40 N was evaluated as “B”.

As a result of measurements of Example 1, α1/α2 was 0.24, the average thickness T of the bonding portions 131 was 0.05 mm, the elastic modulus E of the bonding members 13 at the temperature of −30° C. was 1030 MPa, the delamination force was 53 N, and the change in the fixed position was 3.2 μm.

The change in the fixed position of Example 1 was 3.2 and therefore the evaluation result was “A”. The delamination force of Example 1 was 53 N, and therefore the evaluation result was “A”.

### Example 2

In Example 2, as the lens 11, a glass lens formed from optical glass BK7 manufactured by OHARA INC. was prepared. In addition, in Example 2, as the lens 12, a resin lens formed from resin ZEONEX E480R manufactured by Zeon Corporation was prepared. The optical unit 100 was manufactured in substantially the same conditions as in Example 1 except these.

As a result of measurements of Example 2, α1/α2 was 0.10, the average thickness T of the bonding portions 131 was 0.05 mm, the elastic modulus E of the bonding members 13 at the temperature of −30° C. was 1030 MPa, the delamination force was 55 N, and the change in the fixed position was 6.4 μm.

The change in the fixed position of Example 2 was 6.4 and therefore the evaluation result was “A”. The delamination force of Example 2 was 55 N, and therefore the evaluation result was “A”. The reason why the change in the fixed position in Example 2 was larger than in Example 1 can be considered to be because the value of α1/α2 was smaller than in Example 1.

### Example 3

In Example 3, as the adhesive, a UV-curable adhesive CHEMISEAL U-1558D manufactured by CHEMITECH INC. was used. The elastic modulus E at −30° C. of the cured product obtained by curing this adhesive was 1700 MPa. The optical unit 100 was manufactured in substantially the same conditions as in Example 1 except this.

As a result of measurements of Example 3, α1/α2 was 0.24, the average thickness T of the bonding portions 131 was 0.05 mm, the elastic modulus E of the bonding members 13 at the temperature of −30° C. was 1700 MPa, the delamination force was 60 N, and the change in the fixed position was 3.8 μm.

The change in the fixed position of Example 3 was 3.8 and therefore the evaluation result was “A”. The delamination force of Example 3 was 60 N, and therefore the evaluation result was “A”.

### Example 4

In Example 4, the average thickness T of the bonding portions 131 was set to 0.01 mm. In addition, in Example 4, as the adhesive, a UV-curable adhesive XVL-14L manufactured by Kyoritsu Chemical & Co., Ltd. was used. The elastic modulus E at −30° C. of the cured product obtained by curing this adhesive was 200 MPa. The optical unit 100 was manufactured in substantially the same conditions as in Example 1 except these.

As a result of measurements of Example 4, α1/α2 was 0.24, the average thickness T of the bonding portions 131 was 0.01 mm, the elastic modulus E of the bonding members 13 at the temperature of −30° C. was 200 MPa, the delamination force was 42 N, and the change in the fixed position was 2.8 μm.

The change in the fixed position of Example 4 was 2.8 and therefore the evaluation result was “A”. In addition, the delamination force of Example 4 was 42 N, and therefore the evaluation result was “A”. The reason why the change in the fixed position in Example 4 was smaller than in Example 1 can be considered to be because the elastic modulus E of the bonding portion 131 was smaller than in Example 1 and thus the thermal stress of the bonding portions 131 was reduced.

### Example 5

In Example 5, the average thickness T of the bonding portions 131 was set to 0.02 mm. In addition, in Example 5, as the adhesive, a UV-curable adhesive XVL-90T3 manufactured by Kyoritsu Chemical & Co., Ltd. was used. The elastic modulus E at −30° C. of the cured product obtained by curing this adhesive was 400 MPa. The optical unit 100 was manufactured in substantially the same conditions as in Example 1 except these.

As a result of measurements of Example 5, α1/α2 was 0.24, the average thickness T of the bonding portions 131 was 0.02 mm, the elastic modulus E of the bonding members 13 at the temperature of −30° C. was 400 MPa, the delamination force was 44 N, and the change in the fixed position was 3.2 μm.

The change in the fixed position of Example 5 was 3.2 and therefore the evaluation result was “A”. In addition, the delamination force of Example 5 was 44 N, and therefore the evaluation result was “A”.

### Example 6

In Example 6, the average thickness T of the bonding portions 131 was set to 0.03 mm. The optical unit 100 was manufactured in substantially the same conditions as in Example 1 except this.

As a result of measurements of Example 6, α1/α2 was 0.24, the average thickness T of the bonding portions 131 was 0.03 mm, the elastic modulus E of the bonding members 13 at the temperature of −30° C. was 1030 MPa, the delamination force was 53 N, and the change in the fixed position was 6.2 μm.

The change in the fixed position of Example 6 was 6.2 and therefore the evaluation result was “A”. In addition, the delamination force of Example 6 was 53 N, and therefore the evaluation result was “A”. The reason why the change in the fixed position in Example 6 was larger than in Example 1 can be considered to be because the average thickness T of the bonding portions 131 was smaller than in Example 1 and thus the thermal stress of the bonding portion 131 was increased.

### Example 7

In Example 7, the average thickness T of the bonding portions 131 was set to 0.04 mm. The optical unit 100 was manufactured in substantially the same conditions as in Example 5 except this.

As a result of measurements of Example 7, α1/α2 was 0.24, the average thickness T of the bonding portions 131 was 0.04 mm, the elastic modulus E of the bonding members 13 at the temperature of −30° C. was 400 MPa, the delamination force was 47 N, and the change in the fixed position was 3.0 μm.

The change in the fixed position of Example 7 was 3.0 and therefore the evaluation result was “A”. In addition, the delamination force of Example 7 was 47 N, and therefore the evaluation result was “A”.

### Comparative Example 1

In Comparative Example 1, as the adhesive, a UV-curable adhesive CHEMISEAL U-2043V manufactured by CHEMITECH INC. was used. The elastic modulus E at −30° C. of the cured product obtained by curing this adhesive was 2600 MPa. The optical unit 100X was manufactured in substantially the same conditions as in Example 1 except these.

As a result of measurements of Comparative Example 1, α1/α2 was 0.24, the average thickness T of the bonding portions 131 was 0.05 mm, the elastic modulus E of the bonding members 13X at the temperature of −30° C. was 2600 MPa, the delamination force was 35 N, and the change in the fixed position was 21 μm.

The change in the fixed position of Comparative Example 1 was 21 and therefore the evaluation result was “B”. In addition, the delamination force of Comparative Example 1 was 35 N, and therefore the evaluation result was “B”.

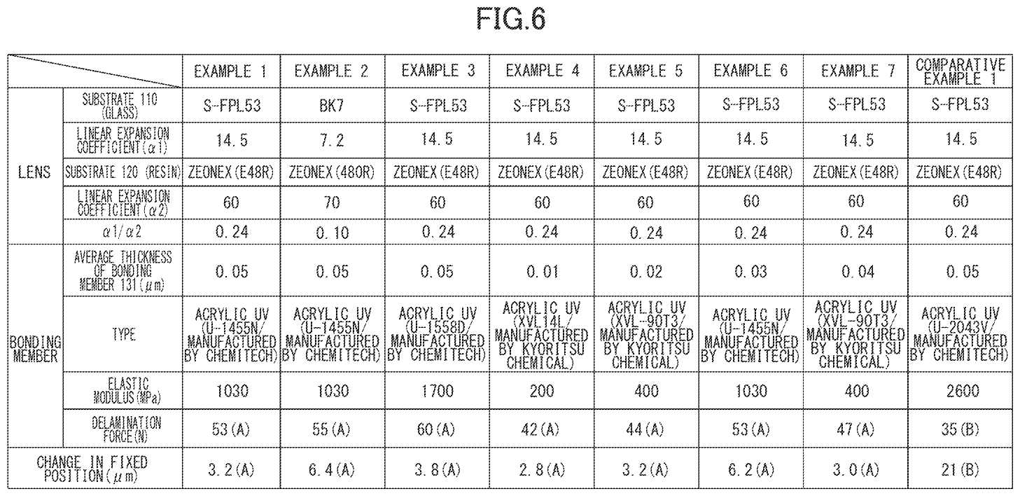

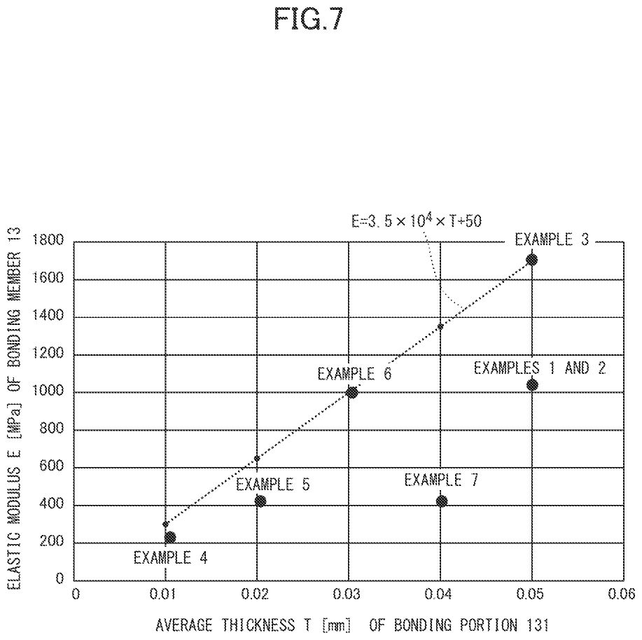

A table of FIG. 6 shows conditions and results of Examples 1 to 7 and Comparative Example 1 described above. In addition, a graph of FIG. 7 shows the results of Examples 1 to 7 shown in FIG. 6. The elastic modulus of each of the bonding members 13 at the temperature of −30° C. is denoted by E [MPa], and the average thickness of the bonding portion 131 of each of the bonding members 13 is denoted by T [mm]. In FIG. 7, the horizontal axis represents the average thickness T [mm] of the bonding portion 131, and the vertical axis represents the elastic modulus E [MPa] of the bonding member 13. In the results shown in FIG. 7, Examples 1 to 7 each fall within a range of E≤3.5×10⁴×T−50. Therefore, it is preferable that E≤3.5×10⁴×T−50 is satisfied.

### Second Embodiment

### Optical Unit

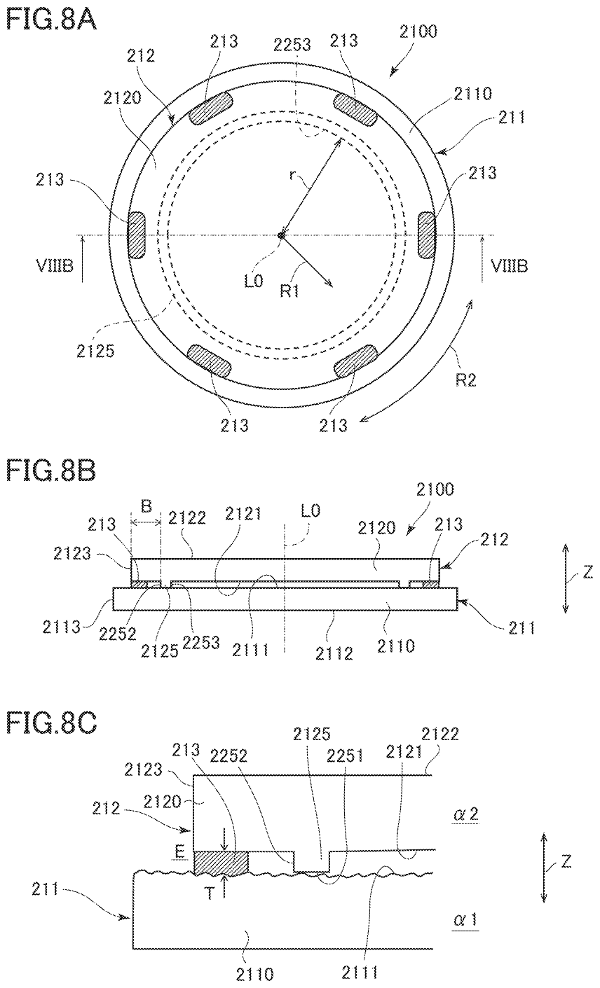

FIG. 8A is a plan view of an optical unit 2100 according to a second embodiment. FIG. 8B is a section view of the optical unit 2100 according to the second embodiment. FIG. 8C is an enlarged section view of the optical unit 2100 according to the second embodiment. FIG. 8B illustrates a cross-section of the optical unit 2100 taken along a line VIIIB-VIIIB of FIG. 8A. FIG. 8C illustrates part of FIG. 8B in an enlarged form. In the second embodiment, the optical unit 100 in the optical element 10 included in the lens barrel 601 of the digital camera 600 of FIG. 1 is replaced by the optical unit 2100.

The optical unit 2100 includes a lens 211 and a lens 212. The lens 211 and the lens 212 are disposed in contact with each other in a state in which the center axis of the lens 211 and the center axis of the lens 212 coincide with each other.

The lenses 211 and 212 each have a circular outer shape as viewed in the direction of the optical axis L0. The optical axis L0 also serves as a center axis that passes through the center of each of the lenses 211 and 212. The lens 211 is larger than the lens 212 as viewed in the direction of the optical axis L0. That is, the lens 211 has a larger diameter than the lens 212. In the description below, the direction of the optical axis L0 will be referred to as a Z direction. In addition, a direction orthogonal to the optical axis L0 and extending from the optical axis L0 will be referred to as a radial direction R1. In addition, a direction about the optical axis L0 centered on the optical axis L0 will be referred to as a peripheral direction R2.

The lens 211 includes a main surface 2111 serving as a first main surface, a main surface 2112 on the back side of the main surface 2111, and an outer peripheral surface 2113. The lens 212 includes a main surface 2121 serving as a second main surface, a main surface 2122 on the back side of the main surface 2121, and an outer peripheral surface 2123. Part or entirety of the main surfaces 2111, 2112, 2121, and 2122 is used as an optical functional surface.

The main surface 2121 is separated from the main surface 2111 in the Z direction and faces the main surface 2111. That is, there is a distance between the main surfaces 2111 and 2121. The shape of each of the main surfaces 2111, 2112, 2121, and 2122 is not limited, and one of shapes such as a concave spherical surface, a convex spherical surface, a axially-symmetrical aspherical surface, and a flat surface is preferable.

The lens 211 is fixed to the inner wall 6041 of the inner barrel 604 illustrated in FIG. 1. In the second embodiment, the inner barrel 604 is formed of resin. The lens 211 is fixed to the inner barrel 604 by heat caulking.

The lens 212 includes a projection portion 2125 projecting with respect to the main surface 2121. The projection portion 2125 projects toward the main surface 2111 of the lens 211. In the second embodiment, the projection portion 2125 is formed in an annular shape as viewed in the Z direction. The projection portion 2125 is provided for positioning the main surface 2121 in a predetermined distance from the main surface 2111, and is provided in contact with the main surface 2111. As a result of this, the lens 212 is positioned with high precision with respect to the lens 211 such that the main surface 2121 is provided in a predetermined distance from the main surface 2111 in the Z direction. To be noted, depending on the shapes of the lenses 211 and 212, the main surfaces 2121 and 2111 can be positioned without providing the projection portion 2125. Therefore, the main surface 2121 does not have to have the projection portion 2125. However, from the viewpoint of positioning the lens 212 with high precision with respect to the lens 211, it is more preferable that the main surface 2121 includes the projection portion 2125.

The projection portion 2125 includes an end surface 2251 that is a distal end surface. The end surface 2251 faces the main surface 2111, and is partially in contact with the main surface 2111. That is, the end surface 2251 and/or the main surface 2111 are rough surfaces, and therefore the end surface 2251 is partially in contact with the main surface 2111. Specifically, at least one of the main surface 2111 and the end surface 2251 is not a smooth surface, and is a surface that is uneven in a micrometer order or a sub-micrometer order. In the example of FIG. 8C, the main surface 2111 is a rough surface. Therefore, the end surface 2251 is partially in contact with the main surface 2111, and there is a small gap between the main surface 2111 and the end surface 2251 in a portion where these two are not in contact with each other.

The lens 211 includes a substrate 2110 serving as an example of a first transparent substrate. The substrate 2110 is a lens body. The lens 211 may include a functional film formed on the surface of the substrate 2110. The functional film is constituted by at least one functional layer. The functional layer is a coating layer, and examples thereof include an antireflection layer, a hydrophilic layer, and the like. For example, the antireflection layer is formed from a paint including particles of a size in a micrometer order. For example, the hydrophilic layer includes Sift.

The lens 212 includes a substrate 2120 serving as an example of a second transparent substrate. The substrate 2120 is a lens body. The lens 212 may include a functional film formed on the surface of the substrate 2120. The functional film is constituted by at least one functional layer. The functional layer is a coating layer, and examples thereof include an antireflection layer, a hydrophilic layer, and the like. For example, the hydrophilic layer includes SiO₂.

The material of the substrate 2110 is glass such as optical glass. The glass can be selected from silicate glass, borosilicate glass, phosphate glass, quartz glass, glass ceramics, and the like.

The material of the substrate 2120 is different from the material of the substrate 2110, and is resin in the second embodiment. The resin is preferably optical resin. The optical resin can be selected from cycloolefin polymer, acrylic resin, polyester resin, polycarbonate, and the like.

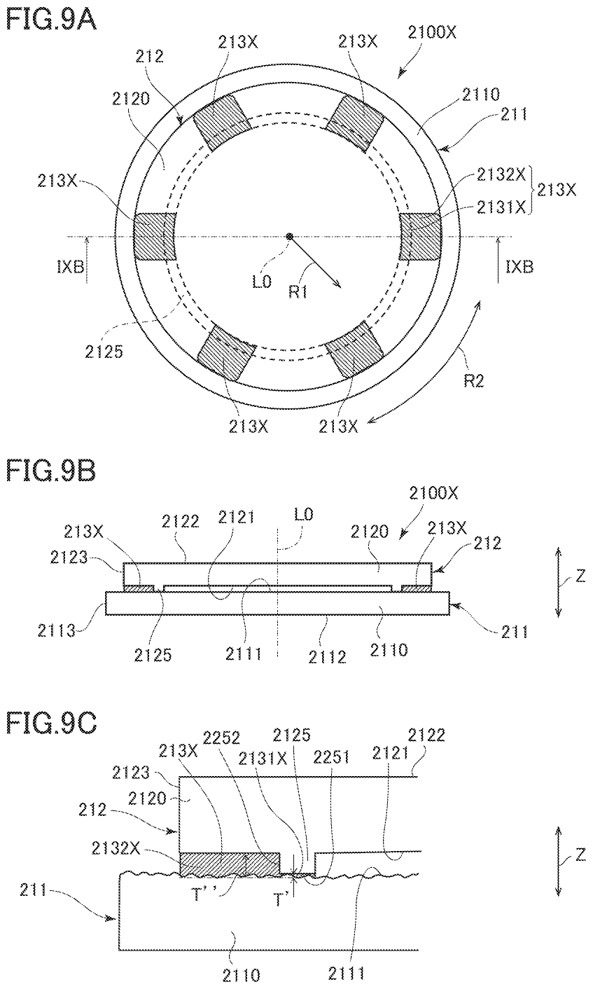

Here, an optical unit of a second comparative example will be described. To be noted, in the description below, the lens 211 will be also referred to as a glass lens, and the lens 212 will be also referred to as a resin lens. FIG. 9A is a plan view of an optical unit 2100X of the second comparative example. FIG. 9B is a section view of the optical unit 2100X of the second comparative example. FIG. 9C is an enlarged section view of the optical unit 2100X of the second comparative example. FIG. 9B illustrates a cross-section of the optical unit 2100X taken along a line IXB-IXB of FIG. 9A. FIG. 9C illustrates part of FIG. 9B in an enlarged form.

The optical unit 2100X of the second comparative example includes the lenses 211 and 212 similarly to the second embodiment. The optical unit 2100X of the second comparative example includes a plurality of, for example, six bonding members 213X. The plurality of bonding members 213X are arranged at intervals in the peripheral direction R2. Each of the bonding members 213X is disposed between the lenses 211 and 212. Further, the bonding members 213X are each disposed in contact with the main surfaces 2111 and 2121. At least part of each of the bonding members 213X is present in a gap between the main surface 2111 of the lens 211 and the end surface 2251 of the projection portion 2125 of the lens 212.

That is, the bonding members 213X each include a bonding portion 2131X present in the gap between the main surface 2111 and the end surface 2251, and a bonding portion 2132X that is in contact with the main surfaces 2111 and 2121 and an outer side surface 2252 of the projection portion 2125. The bonding portions 2131X and 2132X are continuously and integrally formed.

When the optical device including the optical unit 2100X of the second comparative example is used in a low-temperature environment and then is returned from the low-temperature environment to a room-temperature environment, a phenomenon of the lens 212 relatively displacing, that is, becoming eccentric with respect to the lens 211 occurs in some cases. As described above, there is a possibility that the fixed position of the lens 212 with respect to the lens 211 is changed and the image pickup performance deteriorates.

Therefore, the present inventors observed the optical unit 2100X, and as a result, confirmed that the bonding portions 2131X included in some of the plurality of bonding members 213X were partially or entirely peeled off from the projection portion 2125 or the lens 211. For example, this is a phenomenon in which the bonding portion 2131X is partially or entirely peeled off in each of four bonding members 213X among the six bonding members 213X. The present inventors considered that, as a result of occurrence of such interface delamination, an imbalance in the adhesive force occurs between the bonding members 213X, and the lens 212 becomes eccentric with respect to the lens 211 when the optical unit 2100X returns from the low-temperature environment to the room-temperature environment.

The present inventors reached the following idea on the cause of occurrence of such interface delamination. That is, the material of the substrate 2120 is different from the material of the substrate 2110. Since the material of the substrate 2120 is different from the material of the substrate 2110, the linear expansion coefficient of the substrate 2120 is different from the linear expansion coefficient of the substrate 2110. That is, the linear expansion coefficient of the substrate 2110 formed of glass is smaller than the linear expansion coefficient of the substrate 2120 formed of resin. In the case where the temperature of the environment in which the optical unit 2100X is put changes from a room temperature to a low temperature, the thermal contraction amount in the radial direction R1 is larger for the lens 212 including the substrate 2120 formed of resin than the lens 211 including the substrate 2110 formed of glass. Here, the room temperature is a normal temperature, for example, 23° C.±2° C. In addition, the low temperature is below the freezing point. In the case where the optical device is used in the low-temperature environment, thermal stress is generated in each of the bonding members 213X due to the difference between the thermal contraction amount of the lens 211 and the thermal contraction amount of the lens 212. In addition, the thickness T′ of the bonding portions 2131X is smaller than the thickness T″ of the bonding portions 2132X. Therefore, it can be considered that the bonding portions 2131X thinner than the bonding portions 2132X could not follow the contraction of the lenses 211 and 212 in the radial direction R1, and thus the interface delamination occurred in the bonding portions 2131X of the bonding members 213X due to the occurrence of the thermal stress in the bonding portions 2131X of the bonding members 213X.

As illustrated in FIG. 8A, the optical unit 2100 of the second embodiment includes at least one bonding member formed from an adhesive. In the second embodiment, the optical unit 2100 includes a plurality of, for example, six bonding members 213. The bonding members 213 each have a different shape from the bonding members 213X. That is, the bonding members 213 are each not present in the gap between the main surface 2111 and the end surface 2251 unlike the bonding members 213X of the second comparative example.

The lenses 211 and 212 are bonded together via the plurality of bonding members 213. In the second embodiment, the lens 212 is glued and fixed to the lens 211 via the plurality of bonding members 213. The plurality of bonding members 213 are arranged at intervals in the peripheral direction R2. In the second embodiment, the plurality of bonding members 213 are arranged in the peripheral direction R2 at equal intervals, for example, at an interval of 60° each about the optical axis L0. Each of the bonding members 213 is partially or entirely disposed between the lenses 211 and 212. In the second embodiment, the bonding members 213 are entirely disposed between the lenses 211 and 212. Further, the bonding members 213 are each disposed in contact with the main surfaces 2111 and 2121. That is, the bonding members 213 each bond the main surfaces 2111 and 2121 together. In addition, the bonding members 213 are positioned more on the outside than the projection portion 2125 in the radial direction R1.

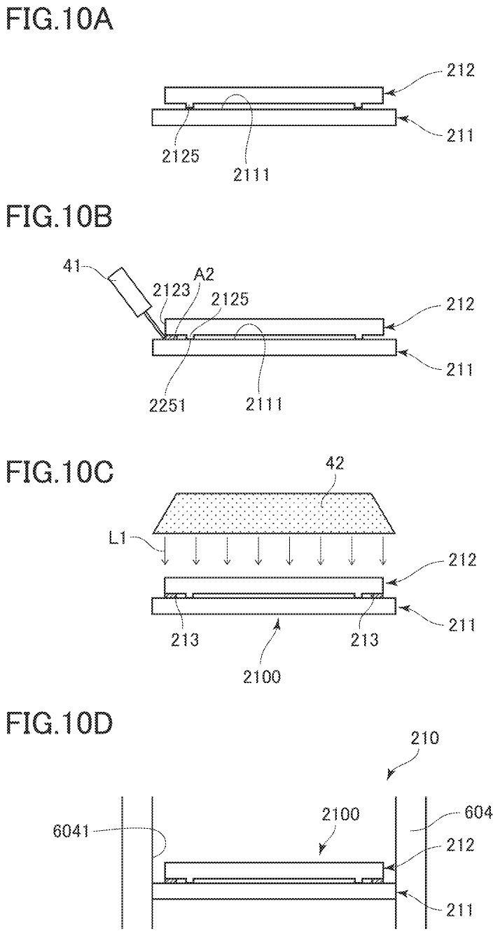

In the second embodiment, the bonding members 213 are each disposed at a position away from the projection portion 2125. That is, there is a gap between the outer side surface 2252 of the projection portion 2125 and each of the bonding members 213. As a result of this, the bonding members 213 each do not include the thin bonding portion 2131X unlike the second comparative example, and thus occurrence of the interface delamination at the bonding members 213 can be reduced. That is, the thickness T of each of the bonding members 213 is equal to the distance between the main surfaces 2111 and 2121, and is larger than the thickness T′ of the second comparative example. Therefore, occurrence of the interface delamination at each of the bonding members 213 in the low-temperature environment can be reduced. Therefore, even when the optical element 210 of FIG. 10D that will be described later is exposed to the low-temperature environment and then the temperature of the environment in which the optical element 210 is put is changed from the low temperature to the room temperature, the balance of the adhesive force in the bonding members 213 can be maintained, and thus the relative displacement of the lens 212 with respect to the lens 211, that is, eccentricity can be reduced. Focusing on the lens 212 as a standard, the relative displacement of the lens 211 with respect to the lens 212 can be reduced.

In addition, since the plurality of bonding members 213 are arranged at equal intervals in the peripheral direction R2, the stress generated in the bonding members 213 by the thermal contraction of the lenses 211 and 212 is equalized, and thus the displacement of the lens 212 with respect to the lens 211 is reduced.

Here, even if the lens 211 includes a functional film, since most part of the lens 211 is the substrate 2110, the thermal contraction of the substrate 2110 can be regarded as the thermal contraction of the lens 211. In addition, even if the lens 212 includes a functional film, since most part of the lens 212 is the substrate 2120, the thermal contraction of the substrate 2120 can be regarded as the thermal contraction of the lens 212.

A hydrophilic layer formed of SiO₂ or the like may be used as a functional film formed on the surface of each of the substrates 2110 and 2120 or an outer layer on the functional film. As a result of this, the tightness of adhesion of the bonding portion 2131 at the bonding interface can be improved, and thus peeling of the bonding portion 2131 can be effectively reduced. In addition, surface modification such as chemically bonding a carbonyl group, a carboxyl group, or the like to the surface by plasma treatment in atmospheric pressure or UV ozone treatment may be performed on the surface of each of the lenses 211 and 212. As a result of this, the tightness of adhesion of the bonding portion 2131 at the bonding interface can be improved, and peeling of the bonding portion 2131 can be effectively reduced.

The linear expansion coefficient of the substrate 2110 is denoted by al, and the linear expansion coefficient of the substrate 2120 is denoted by α2. The second embodiment is more effective in the case there is a big difference between the linear expansion coefficient α1 of the substrate 2110 and the linear expansion coefficient α2 of the substrate 2120 satisfying α1/α2≤0.2. That is, even in the case of a combination in which there is a big difference between the linear expansion coefficients α1 and α2 that satisfy α1/α2≤0.2, the thermal stress generated in each of the bonding members 213 can be effectively relieved, and peeling of the bonding members 213 can be effectively reduced. Therefore, relative displacement of the lens 212 with respect to the lens 211, that is, eccentricity can be effectively reduced.

To be noted, the size relationship between the lenses 211 and 212 is not limited to the relationship described above. In addition, as the radius of the lens 212 including the substrate 2120 formed of resin increases, the contraction amount of the lens 212 in the radial direction R1 at a low temperature increases. Therefore, the thermal stress generated in the bonding members 213 also increases, but since the bonding members 213 each have the configuration described above, the eccentricity of the lens 212 with respect to the lens 211 can be reduced.

Next, the adhesive used for forming the bonding members 213 will be described. The bonding members 213 are cured products of the adhesive, and the adhesive includes uncured resin. The bonding members 213 include cured products of resin. The bonding members 213 are each preferably a cured product of a cross-linking adhesive. That is, the adhesive is preferably a cross-linking adhesive. As the cross-linking adhesive, for example, a photocurable adhesive such as a UV-curable adhesive containing UV-curable resin, a heat-curable adhesive, or a moisture-curable adhesive can be used. Among these kinds of adhesives, the photocurable adhesive is more preferable. Among photocurable adhesives, UV-curable adhesives are more preferable. The UV-curable adhesive can be instantly cured by being irradiated with UV light. Therefore, the operability in the application and the adhesive force can be improved. In addition, permeation of the adhesive into a gap between the end surface 2251 of the projection portion 2125 and the main surface 2111 can be easily suppressed.

The UV-curable adhesive preferably contains a photopolymerization initiator (A), a urethane-modified (meth)acrylate (B), and an acrylate monomer (C). Further, the UV-curable adhesive preferably contains a thixotropy imparting material (D) such as silica fine particles for the purpose of adjusting the viscosity of the adhesive. In addition, the UV-curable adhesive preferably contains spherical filler such as crystalline silica as an additive (E) for adjusting the hardness of the cured adhesive. For the purpose of improving the adhesivity to the bonding target, a silane coupling agent may be added to the UV-curable adhesive.

The photopolymerization initiator (A) is not limited, and examples thereof include 2,4,6-trimethylbenzoyldiphenylphosphine oxide, 2,4,6-trimethylbenzoylphenylethoxyphosphine oxide, bis(2,6-dimethoxybenzoyl)-2,4,4-trimethyl-pentylphosphine oxide, 1-hydroxycyclohexyl phenyl ketone (Irgacure 184; manufactured by BASF), 2-hydroxy-2-methyl-[4-(1-methylvinyl)phenyl]propanol oligomer (ESACURE ONE; manufactured by Lamberti), 1-[4-(2-hydroxyethoxy)-phenyl]-2-hydroxy-2-methyl-1-propane-1-one (Irgacure 2959; manufactured by BASF), 2-hydroxy-1-{4-[4-(2-hydroxy-2-methyl-propionyl)-benzyl]-phenyl}-2-methyl-propane-1-one (Irgacure 127; manufactured by BASF), 2,2-dimethoxy-2-phenylacetophenone (Irgacure 651; manufactured by BASF), 2-hydroxy-2-methyl-1-phenyl-propane-1-one (DAROCUR 1173; manufactured by BASF), 2-methyl-1-[4-(methylthio)phenyl] morpholinopropane-1-one (Irgacure 907; manufactured by BASF), 2-benzyl-2-dimethylamino-1-(4-morpholinophenyl)-butane-1-one, 2-chlorothioxanthone, 2,4-diethylthioxanthone (KAYACURE DETX-S; manufactured by Nippon Kayaku Co., Ltd.), 2,4-dimethylthioxanthone, 2,4-diisopropylthioxanthone, isopropylthioxanthone, 1,2-octanedione,1-[4-(phenylthio)-phenyl,2-(o-benzoyloxime)] (Irgacure OXE01; manufactured by BASF), and a mixture (Irgacure 754) of 2-[2-oxo-2-phenylacetoxyethoxy]ethyl oxyphenylacetate an 2-(2-hydroxy-ethoxy)ethyl oxyphenylacetate.

The urethane-modified (meth)acrylate (B) preferably has a polyether skeleton having flexibility. Examples of the polyether skeleton include a structure obtained by further reacting a diisocyanate compound, which is a reaction product of polyalkylene glycol and diisocyanate, with an acrylate having a hydroxyl group.

The acrylate monomer (C) is not limited, and (meth)acrylate having one (meth)acryloyl group within the molecule can be preferably used. Specific examples thereof include (meth)acrylates having 5 to 25 carbon atoms such as octyl (meth)acrylate, isooctyl (meth)acrylate, isoamyl (meth)acrylate, lauryl (meth)acrylate, isodecyl (meth)acrylate, stearyl (meth)acrylate, cetyl (meth)acrylate, isomyristyl (meth)acrylate, isostearyl (meth)acrylate, and tridecyl (meth)acrylate, (meth)acrylates having a cyclic skeleton such as benzyl (meth)acrylate, tetrahydrofurfuryl (meth)acrylate, acryloylmorpholine, cyclic trimethylolpropane formal acrylate, phenylglycidyl (meth)acrylate, tricyclodecane (meth)acrylate, dicyclopentenyl acrylate, dicyclopentenyloxyethyl (meth)acrylate, isobornyl (meth)acrylate, dicyclopentanyl (meth)acrylate, 1-adamantyl acrylate, 2-methyl-2-adamantyl acrylate, 2-ethyl-2-adamantyl acrylate, 1-adamantyl methacrylate, polypropylene oxide-modified nonylphenyl (meth)acrylate, ethoxylated o-phenylphenol acrylate, and dicyclopentadieneoxyethyl (meth)acrylate, (meth)acrylates having a hydroxyl group and 2 to 7 carbon atoms, polyalkylene glycol (meth)acrylates such as ethoxydiethylene glycol (meth)acrylate, polypropylene glycol (meth)acrylate, and polypropylene oxide-modified nonylphenyl (meth)acrylate, ethylene oxide-modified phenoxylated phosphoric acid (meth)acrylate, ethylene oxide-modified butoxylated phosphoric acid (meth)acrylate, ethylene oxide-modified octyloxylated phosphoric acid (meth)acrylate, and caprolactone-modified tetrafurfuryl (meth)acrylate. In addition, the adhesive preferably contains amide group-containing (meth)acrylate for the purpose of improving adhesion to a resin lens. Examples of the amide group-containing (meth) acrylate include N,N-dimethyl(meth)acrylamide, N,N-diethyl(meth)acrylamide, N,N-dipropyl(meth)acrylamide, N-methyl(meth)acrylamide, N-ethyl(meth)acrylamide, N-isopropylacrylamide, N-butyl(meth)acrylamide, N,N-butoxymethyl(meth)acrylamide, hydroxyethylacrylamide, and acryloylmorpholine, and one or more of these can be used in combination. Among these, N,N-dimethylacrylamide (DMAA) is preferably used due to its excellent adhesivity with cycloolefine polymer that is a matter difficult to adhere to as resin lens.

To confirm whether or not the bonding member 213 contains N,N-dimethylacrylamide, analysis can be performed by using a gas chromatograph mass spectrometer. At this time, it is preferable that a thermal desorption apparatus or a head space sampler is provided as a preprocessing apparatus. As the preprocessing conditions, for example, the heating temperature is set to 80° C., and the heating time is set to 30 minutes. As the temperature condition of the gas chromatograph, for example, the temperature is held at 40° C. for 3 minutes, then is raised to 320° C. at a temperature increase speed of 20° C./min, and is then held for 5 minutes at 320° C. As a result of this, N,N-dimethylacrylamide can be detected. In the case of performing mass analysis by the electron ionization method: EI method that is the most commonly used method in gas chromatograph mass analysis, whether or not N,N-dimethylacrylamide is detected can be easily determined by focusing on m/z=55, 72, and 99. The apparatus for the gas chromatograph mass analysis is not limited, and examples thereof include Trace GC Ultra manufactured by Thermo Fisher Scientific.

Here, in a condition where α1<α2 holds, assuming a case where α1/α2 is smaller, the substrate 2120 having the linear expansion coefficient of α2 is relatively thermally contracted with respect to the substrate 2110 having the linear expansion coefficient of al at the low temperature. Therefore, from the viewpoint of causing the bonding members 213 to follow the difference in the thermal contraction amount between the substrates 2110 and 2120, the elastic modulus E of each of the bonding members 213 is preferably as small as possible at the temperature of −30° C. In the second embodiment, the elastic modulus E is storage elastic modulus. To be noted, micro-indentation hardness tester including a nanoindenter can be used for the measurement of the elastic modulus E of the bonding members 213 at the temperature of −30° C.

The thickness T of the bonding member 213 is preferably thicker from the viewpoint of ease of following the difference in the thermal contraction amount between the substrates 2110 and 2120. In the case where the thickness T of the bonding member 213 is large, even if an adhesive having a relatively large elastic modulus E is applied, the delamination in the low temperature environment can be reduced, the change in the fixed position of the lens 212 with respect to the lens 211 can be reduced, and high adhesive force can be maintained as a result of the large elastic modulus E.

The thickness T of the bonding member 213 is preferably 0.2 mm to 1.5 mm from the viewpoint of ensuring high adhesive force and reducing the change in the fixed position. The thickness T of the bonding member 213 is more preferably 0.5 mm to 1.1 mm. In addition, in the case where the thickness T of the bonding member 213 is small, it is preferable to select an adhesive that makes the elastic modulus E of the bonding member 213 at the temperature of −30° C. small from the viewpoint of reducing the thermal stress. The elastic modulus E of the bonding member 213 at the temperature of −30° C. is preferably 0.5 GPa to 1.7 GPa. The elastic modulus E of the bonding member 213 at the temperature of −30° C. is more preferably 0.7 GPa to 1.2 GPa from the viewpoint of ensuring high adhesive force and reducing the change in the fixed position. Here, −30° C. includes a tolerance of about ±0.5° C.

In the second embodiment, in the case where the elastic modulus of the bonding members 213 at the temperature of −30° C. is denoted by E [GPa] and the thickness of the portion of the bonding members 213 between the lenses 211 and 212 is denoted by T [mm], it is preferable that E≤2.3×T+2.5 is satisfied. As a result of satisfying this relationship, the change in the fixed position of the lens 212 with respect to the lens 211 in the case of using the optical element 210 at the low temperature can be further reduced. To be noted, the thickness T is the minimum thickness among the thickness of the portion of the bonding members 213 between the lenses 211 and 212.

In addition, in the case where the diameter of the lens 212 is large, since the contraction amount of the diameter of the lens 212 at the low temperature is large, the thermal stress generated in each of the bonding members 213 is also large. The elastic modulus of the bonding members 213 at the temperature of −30° C. is denoted by E [GPa], the thickness of the portion of the bonding members 213 between the lenses 211 and 212 is denoted by T [mm], and the distance between the center axis of the main surface 2121, that is, the optical axis L0 and the projection portion 2125 in the radial direction R1 is denoted by r [mm]. In the second embodiment, the distance r is the minimum distance from the optical axis L0 to the projection portion 2125. That is, the distance r is the distance from the optical axis L0 to an inner side surface 2253 of the projection portion 2125. The optical unit 2100 preferably satisfies E≤2.3×T−0.08×r+2.5. As a result of satisfying this relationship, the change in the fixed position of the lens 212 with respect to the lens 211 can be more effectively reduced.

### Manufacturing Method for Optical Element

A manufacturing method for the optical element 210 will be described. FIGS. 10A to 10D are explanatory diagrams of respective steps of the manufacturing method for the optical element 210 according to the second embodiment.

First, as illustrated in FIG. 10A, the lenses 211 and 212 are prepared, and the lenses 211 and 212 are brought into contact with each other. Specifically, the projection portion 2125 of the lens 212 is brought into contact with the main surface 2111 of the lens 211. At this time, the positions are adjusted such that the center axis of the lens 211 and the center axis of the lens 212 coincide with each other.

Then, as illustrated in FIG. 10B, an adhesive A2 is supplied to the gap between the lenses 211 and 212. For the supply of the adhesive A2, a publicly known method with which the adhesive A2 can be discharged by a constant amount is used. For example, the adhesive A2 is applied to the gap between the lenses 211 and 212 from the vicinity of the outer peripheral surface 2123 of the lens 212 by using an air dispenser 41 or the like. In the second embodiment, the adhesive A2 is applied on six positions at equal intervals in the peripheral direction R2 illustrated in FIG. 8A.

When the adhesive A2 is applied on each position, the adhesive A2 at each position wet-spreads between the lenses 211 and 212, but does not wet-spreads to the projection portion 2125, and is thus separated from the projection portion 2125. The viscosity of the adhesive A2 is not limited, but is preferably 3000 mPas or more. In the case where the viscosity of the adhesive A2 is 3000 mPas or more, the adhesive A2 is not likely to wet-spread to the projection portion 2125.

From the viewpoint of ensuring operability of the application of the adhesive A2 and suppressing permeation of the adhesive A2 to the gap between the end surface 2251 of the projection portion 2125 and the main surface 2111, the viscosity of the adhesive A2 is further preferably 6000 mPa·sec or more and less than 30000 mPa·sec. If the viscosity is 30000 mPa·sec or more, the wettability of the adhesive on the lenses 211 and 212 is low, and there is a possibility that sufficient adhesive force cannot be obtained. The viscosity of the adhesive A2 can be adjusted by adjusting a composition ratio of the urethane-modified acrylate (B) and the acrylate monomer (C).

As a method for obtaining the state in which the adhesive A2 is separated from the projection portion 2125, the following can be considered. For example, the viscosity may be adjusted by adding a thixotropy imparting material (D) such as silica fine particles to the adhesive A2 because this allows adjusting only the viscosity of the adhesive while maintaining the mechanical properties such as the adhesivity and hardness of the adhesive. In addition, for example, for preventing the adhesive A2 from contacting the projection portion 2125, it is also effective to apply in advance, on a contact portion between the resin lens and the glass lens, a fluid such as grease that does not mix with the adhesive and maintains fluidity after irradiation with UV light.

Then, the adhesive A2 is cured. The adhesive A2 is, for example, a UV-curable adhesive. As illustrated in FIG. 10C, the adhesive A2 is cured by irradiating the adhesive A2 with UV light L1 from a light source 42. For example, a high-pressure mercury lamp, an LED irradiator, or the like can be used as the light source 42. By curing the adhesive A2, the bonding members 213 fixing the lens 212 to the lens 211 are formed. The bonding members 213 are separated from the projection portion 2125. As a result of the lenses 211 and 212 being bonded together via the bonding members 213, the optical unit 2100 is obtained.

To be noted, the obtained optical unit 2100 may be subjected to annealing treatment. By performing the annealing treatment, the out gas generated from the cured product of the adhesive can be reduced, and the adhesion of the bonding members 213 can be made stronger.

Then, as illustrated in FIG. 10D, the optical unit 2100 is disposed inside the inner barrel 604, part of the inner wall 6041 of the inner barrel 604 is subjected to heat caulking, and thus the lens 211 is fixed to the inner wall 6041 of the inner barrel 604. The optical element 210 is obtained by the steps described above.

To be noted, the order of the steps is not limited to this. For example, the lens 212 may be glued and fixed to the lens 211 after fixing the lens 211 to the inner barrel 604 by heat caulking. In addition, the number of the bonding members 213 is not limited to 6, and may be 2 or more, such as 3.

### Modification Examples of Second Embodiment

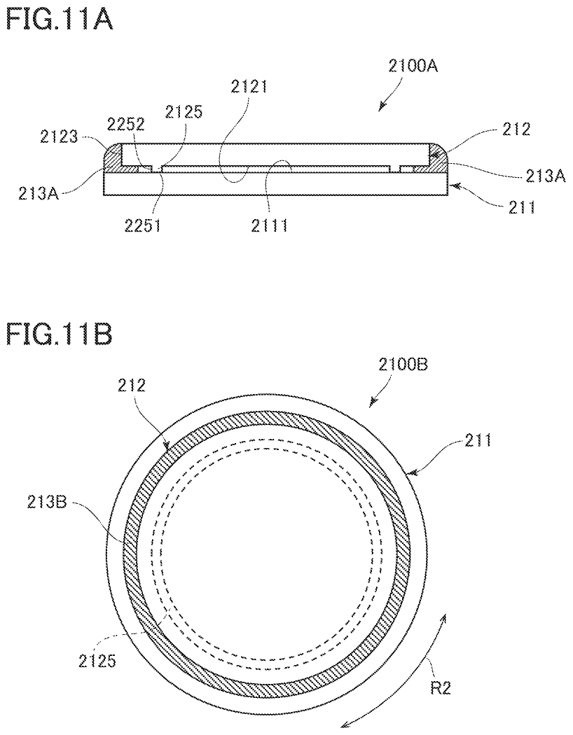

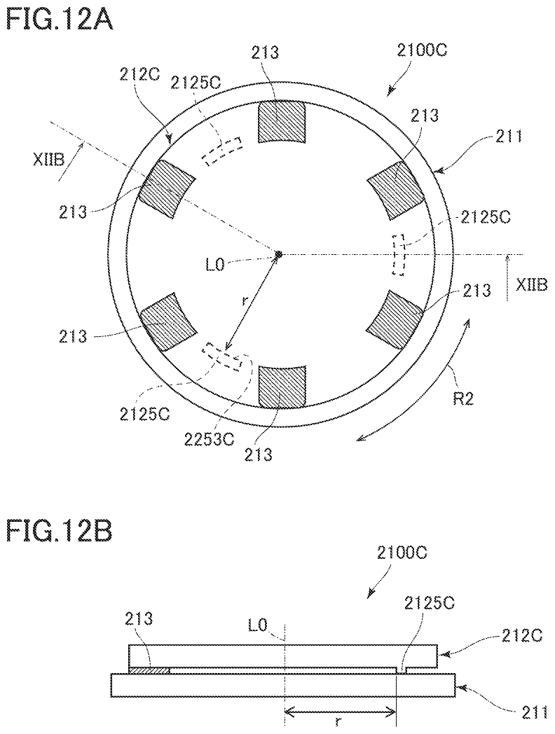

Modification examples of the second embodiment will be described. FIGS. 11A, 11B, 12A, and 12B are explanatory diagrams of optical units of modification examples. FIG. 11A illustrates an optical unit 2100A of a fourth modification example, FIG. 11B illustrates an optical unit 2100B of a fifth modification example, and FIGS. 12A and 12B illustrates an optical unit 2100C of a sixth modification example. FIG. 12B illustrates a cross section of the optical unit 2100C taken along a line XIIB-XIIB of FIG. 12A. To be noted, in the lens barrel of the second embodiment described above, one of the optical units 2100A to 2100C is used in place of the optical unit 2100.

As illustrated in FIG. 11A, the optical unit 2100A includes a plurality of bonding members 213A instead of the plurality of bonding members 213. The bonding members 213A may each be in contact with the main surface 2111 of the lens 211, the main surface 2121 of the lens 212, and the outer peripheral surface 2123 of the lens 212. When manufacturing the optical unit 2100A, the adhesive may be applied to flow out of the lens 212. Since the bonding members 213A are in contact with the outer peripheral surface 2123 of the lens 212, the lens 212 can be more strongly fixed to the lens 211. Therefore, eccentricity of the lens 212 with respect to the lens 211 can be more effectively reduced when the optical element, that is, the digital camera is used in a low-temperature environment.

In addition, as illustrated in FIG. 11B, one bonding member 213B may be disposed to surround the projection portion 2125. The bonding member 213B is separated from the projection portion 2125. When manufacturing the optical unit 2100B, the adhesive may be applied between the lenses 211 and 212 for the entirety in the peripheral direction R2.

In addition, as illustrated in FIGS. 12A and 12B, a lens 212C serving as an example of a second transparent member may include a plurality of projection portions 2125C arranged at intervals in the peripheral direction R2. The plurality of bonding members 213 are disposed at positions away from the projection portions 2125C so as not to be in contact with any of the plurality of projection portions 2125C. To be noted, the distance r is the minimum distance from the center axis of the lens 212, that is, the optical axis L0 to the projection portion 2125C closest to the optical axis L0 among the plurality of projection portions 2125C. That is, the distance r is the distance from the optical axis L0 to the inner side surface 2253C of the projection portion 2125C closest to the optical axis L0.

### EXAMPLES

Examples 8 to 24 corresponding to the second embodiment described above and Comparative Examples 2 and 3 corresponding to the second comparative example described above will be described below as results of experiments.

### Example 8

A manufacturing process of the optical unit 2100 will be described. The lenses 211 and 212 each do not include the functional film, and are respectively constituted by the substrates 2110 and 2120. As the lens 211, a glass lens formed from optical glass S-FPL53 manufactured by OHARA INC. was prepared. The glass lens was a lens which had a diameter of 35 mm, whose R1 surface was a flat surface, and whose R2 surface was a concave spherical surface. The curvature radius R of the concave spherical surface was 190 mm.

As the lens 212, a resin lens formed from resin ZEONEX E48R manufactured by Zeon Corporation was prepared. The resin lens was a lens which had a diameter of 34 mm, whose R1 surface was an aspherical surface, and whose R2 surface was a flat surface. The projection portion 2125 was formed in an annular shape having a height of 0.8 mm. The projection portion 2125 was disposed at a position that is 2 mm inward from the outer peripheral surface 2123 in the radial direction R1. That is, in FIG. 8B, the distance B in the radial direction R1 between the outer peripheral surface 2123 and the outer side surface 2252 of the projection portion 2125 was set to 2 mm. The value of α1/α2 was 0.24.

The positions were adjusted such that the projection portion 2125 of the lens 212 was in contact with the R1 surface of the lens 211, and the center axis of the lens 211 and the center axis of the lens 212 coincided with each other.

The adhesive will be described. The adhesive was a UV-curable adhesive. As the photopolymerization initiator (A), 2 parts by mass of Omnirad 127 manufactured by IGM Resins was prepared. As the urethane-modified acrylate (B), 28 parts by mass of bifunctional urethane acrylate prepolymer UF-8001G manufactured by KYOEISHA CHEMICAL Co., Ltd. having a molecular weight of 4500 was prepared. As the acrylate monomer (C), 27 parts by mass of isobornyl acrylate manufactured by Tokyo Chemical Industry Co., Ltd. and 5 parts by mass of 2-hydroxyethyl methacrylate manufactured by MITSUBISHI GAS CHEMICAL COMPANY, INC. were prepared. As the thixotropy imparting material (D), 5 parts by mass of AEROSIL R972 manufactured by NIPPON AEROSIL CO., LTD. was prepared. As the additive (E), 33 parts by mass of spherical silica KE-S100 manufactured by NIPPON

SHOKUBAI CO., LTD. was prepared. These were mixed until the liquid became homogenous by using a planetary centrifugal mixer ARV-310 manufactured by THINKY CORPORATION, and thus a UV-curable adhesive was obtained. The obtained UV-curable adhesive was charged in a syringe, and vacuum defoaming was performed. The UV-curable adhesive was subjected to measurement by a rotary viscometer ARG2 manufactured by TA Instruments, and the obtained viscosity was 18000 mPa·sec.

A syringe container containing this adhesive was placed in an air pulse-type air dispenser SuperΣ CMIII manufactured by Musashi Engineering, Inc., and 2 mg each of the adhesive was applied on three positions arranged at an interval of 120° each between the lenses 211 and 212. After the elapse of 10 seconds since the last application of the adhesive, the entirety of the lenses 211 and 212 were irradiated with light of 50 mW for 300 seconds by an LED area irradiator having a light wavelength of 365 nm, and thus the optical unit 2100 was obtained.

### Evaluation

The viscosity of the UV-curable adhesive before curing was measured by a rotary viscometer ARG2 manufactured by TA Instruments. The thickness T of each of the bonding members 213 was measured by using an optical interferometer IRMS8599B manufactured by CHINO CORPORATION, and the average value thereof was calculated. The elastic modulus E of the bonding member 213 at −30° C. was measured by using a nanoindenter NanoTest Xtreme manufactured by Japan Laser Corporation that could be used at a low temperature. As a result of observing the bonding members 213 from above with a microscope, the bonding members 213 were not in contact with and were separated from the projection portion 2125.

The fixed position of the lens 212 with respect to the lens 211 was measured in advance at a normal temperature by an image measurement machine NEAIV VHZ-H3030 manufactured by NIKON CORPORATION. Then, the optical unit 2100 was left to stand for 24 hours in a freezer whose inner temperature was −30° C. Thereafter, the optical unit 2100 was taken out from the freezer and returned to the normal temperature, and then the fixed position of the lens 212 with respect to the lens 211 was measured by the above-described image measurement machine in a similar manner. Then, the change in the fixed position of the lens 212 with respect to the lens 211 was calculated.

A case where the change in the fixed position of the lens 212 with respect to the lens 211 was less than 10 μm was evaluated as “A”, and a case where the change in the fixed position was equal to or more than 10 μm was evaluated as “B”.

As a result of the measurement results of Example 8, the change in the fixed position was 2.9 The change in the fixed position of Example 8 was 2.9 and therefore the evaluation result was “A”.

### Example 9

In Example 9, as the lens 211, a glass lens formed from optical glass BK7 manufactured by OHARA INC. was prepared. In addition, in Example 9, as the lens 212, a resin lens formed from resin ZEONEX E480R manufactured by Zeon Corporation was prepared. The optical unit 2100 was manufactured in substantially the same conditions as in Example 8 except these.

The change in the fixed position of Example 9 was 8.1 and therefore the evaluation result was “A”. The reason why the change in the fixed position in Example 9 was larger than in Example 8 can be considered to be because the value of α1/α2 was 0.1, which was smaller than in Example 8.

### Example 10

In Example 10, the application amount of the adhesive was set to 5 mg. In addition, the bonding members 213 were formed to be also in contact with the outer peripheral surface 2123 of the lens 212. The optical unit 2100 was manufactured in substantially the same conditions as in Example 8 except these.

The change in the fixed position of Example 10 was 6.0 and therefore the evaluation result was “A”. It can be considered that the change in the fixed position was smaller in Example 10 because the bonding area of the bonding members 213 with the lens 212 was set to be larger than in Example 9.

### Example 11

In Example 11, the amount of isobornyl acrylate was set to 22 parts by mass, and 5 parts by mass of N,N-dimethylacrylamide (DMAA) manufactured by KJ Chemicals Corporation was used. The optical unit 2100 was manufactured in substantially the same conditions as in Example 10 except these.

The change in the fixed position of Example 11 was 5.2 μm, and therefore the evaluation result was “A”. It can be considered that, in Example 11, as a result of adding N,N-dimethylacrylamide to Example 10, the adhesive force was improved as compared with Example 10, and thus the change in the fixed position became smaller as compared with Example 10.

### Example 12

In Example 12, the amount of UF-8001G was set to 34 parts by mass, the amount of isobornyl acrylate was set to 34 parts by mass, the amount of AEROSIL R972 was set to 6 parts by mass, and the amount of spherical silica KE-S100 manufactured by NIPPON SHOKUBAI CO., LTD. was set to 14 parts by mass. The optical unit 2100 was manufactured in substantially the same conditions as in Example 11 except these.

The change in the fixed position of Example 12 was 4.2 and therefore the evaluation result was “A”. It can be considered that, in Example 12, as a result of the elastic modulus E of the adhesive being smaller than in Example 11, the change in the fixed position was smaller.

### Example 13

In Example 13, the amount of UF-8001G was set to 40 parts by mass, the amount of isobornyl acrylate was set to 40 parts by mass, and the amount of AEROSIL R972 was set to 8 parts by mass. In addition, in Example 13, the spherical silica KE-S100 was not added. The optical unit 2100 was manufactured in substantially the same conditions as in Example 12 except these.

The change in the fixed position of Example 13 was 1.1 and therefore the evaluation result was “A”. It can be considered that, in Example 13, the elastic modulus E of the adhesive was smaller than in Example 12, and thus the change in the fixed position was smaller.

### Example 14

In Example 14, the diameter of the substrate 2110 was set to 45 mm, and the diameter of the substrate 2120 was set to 44 mm. The optical unit 2100 was manufactured in substantially the same conditions as in Example 12 except these.

The change in the fixed position of Example 14 was 4.7 and therefore the evaluation result was “A”. It can be considered that, in Example 14, the change in the fixed position became larger than in Example 12 as a result of increasing the diameter of the substrate 2110.

### Example 15

In Example 15, the diameter of the substrate 2110 was set to 20 mm, and the diameter of the substrate 2120 was set to 19 mm.

The optical unit 2100 was manufactured in substantially the same conditions as in Example 12 except these.

The change in the fixed position of Example 15 was 3.2 and therefore the evaluation result was “A”. It can be considered that, in Example 15, the change in the fixed position became smaller than in Example 12 as a result of reducing the diameter of the substrate 2110.

### Example 16

In Example 16, the height of the projection portion 2125 of the lens 212 was set to 0.1 mm. The optical unit 2100 was manufactured in substantially the same conditions as in Example 11 except these.

The change in the fixed position of Example 16 was 8.2 and therefore the evaluation result was “A”. It can be considered that, in Example 16, the change in the fixed position became larger than in Example 11 as a result of reducing the thickness T of the bonding members 213.

### Example 17

In Example 17, the amount of UF-8001G was set to 40 parts by mass, and the amount of isobornyl acrylate was set to 40 parts by mass. In addition, in Example 17, the amount of AEROSIL R972 was set to 8 parts by mass. In addition, in Example 17, the spherical silica KE-S100 was not added. The optical unit 2100 was manufactured in substantially the same conditions as in Example 16 except these.

The change in the fixed position of Example 17 was 1.9 and therefore the evaluation result was “A”. It can be considered that, in Example 17, the elastic modulus E of the bonding members 213 was smaller than in Example 16, and thus the change in the fixed position was smaller.

### Example 18

In Example 18, the height of the projection portion 2125 of the lens 212 was set to 0.01 mm. The optical unit 2100 was manufactured in substantially the same conditions as in Example 15 except these.

The change in the fixed position of Example 18 was 7.9 and therefore the evaluation result was “A”. It can be considered that, in Example 18, the change in the fixed position became larger than in Example 15 as a result of reducing the thickness T of the bonding members 213.

### Example 19

In Example 19, the height of the projection portion 2125 of the lens 212 was set to 0.01 mm. The optical unit 2100 was manufactured in substantially the same conditions as in Example 17 except these.

The change in the fixed position of Example 19 was 3.0 and therefore the evaluation result was “A”. It can be considered that, in Example 19, the change in the fixed position became larger than in Example 17 as a result of reducing the thickness T of the bonding members 213.

### Example 20

In Example 20, as the lens 211, a glass lens formed from optical glass S-FPL53 manufactured by OHARA INC. was prepared, and as the lens 212, a resin lens formed from resin ZEONEX E48R manufactured by Zeon Corporation was prepared. The optical unit 2100 was manufactured in substantially the same conditions as in Example 16 except these.

The change in the fixed position of Example 20 was 4.0 and therefore the evaluation result was “A”. It can be considered that in Example 20, since α1/α2 increased as compared with Example 16, the thermal stress at the low temperature became smaller, and the change in the fixed position became smaller.

### Example 21

In Example 21, the application amount of the UV-curable adhesive was set to 2 mg. In addition, the bonding members 213 were formed to be not in contact with the outer peripheral surface 2123 of the lens 212. The optical unit 2100 was manufactured in substantially the same conditions as in Example 13 except these.

The change in the fixed position of Example 21 was 4.2 and therefore the evaluation result was “A”. It can be considered that, in Example 21, the change in the fixed position was larger than in Example 13 because the contact area of the bonding members 213 with the lens 212 was reduced.

### Example 22

In Example 22, the amount of UF-8001G was set to 44 parts by mass, and the amount of isobornyl acrylate was set to 44 parts by mass. In addition, in Example 22, the amount of AEROSIL R972 was set to 5 parts by mass. In addition, in Example 22, N,N-dimethylacrylamide (DMAA) and the spherical silica KE-S100 were not added. The optical unit 2100 was manufactured in substantially the same conditions as in Example 13 except these.

The change in the fixed position of Example 22 was 3.8 and therefore the evaluation result was “A”. In addition, it can be considered that, in Example 22, as compared with Example 13, the adhesive force decreased as a result of not containing N,N-dimethylacrylamide, and thus the change in the fixed position increased.

### Comparative Example 2

In Comparative Example 2, the amount of UF-8001G was set to 30 parts by mass, the amount of isobornyl acrylate was set to 29 parts by mass, and the amount of AEROSIL R972 was set to 1 parts by mass. As a result of this, the viscosity of the adhesive was 2000 mPa sec. The optical unit 2100X was manufactured in substantially the same conditions as in Example 8 except these.

The change in the fixed position of Comparative Example 2 was 21 μm, and therefore the evaluation result was “B”. In Comparative Example 2, as compared with Example 8, the viscosity of the adhesive was as low as 2000 mPa·sec, thus the adhesive permeated between the projection portion 2125 and the main surface 2111 to contact the projection portion 2125, and the bonding portions 2131X were formed. It can be considered that, as a result of this, in Comparative Example 2, interface delamination of the bonding portions 2131X occurred, and therefore the change in the fixed position became larger than in Example 8.

### Example 23

In Example 23, grease was applied on the projection portion 2125. The optical unit 2100 was manufactured in substantially the same conditions as in Comparative Example 2 except these.

The change in the fixed position of Example 23 was 2.8 μm, and therefore the evaluation result was “A”. It can be considered that, in Example 23, the bonding members 213 were separated from the projection portion 2125 as a result of the grease, and thus the change in the fixed position decreased as compared with Comparative Example 2.

### Example 24

In Example 24, the adhesive was irradiated with ultraviolet light to cure the adhesive after 1 second from the application of the adhesive. The optical unit 2100 was manufactured in substantially the same conditions as in Comparative Example 2 except these.

The change in the fixed position of Example 24 was 2.8 and therefore the evaluation result was “A”. It can be considered that, in Example 24, the bonding members 213 were separated from the projection portion 2125 as a result of curing the adhesive before the adhesive permeates to the gap between the projection portion 2125 and the main surface 2111, and thus the change in the fixed position decreased as compared with Comparative Example 2.

### Comparative Example 3

In Comparative Example 3, the lens 212 in which the distance B in the radial direction R1 between the outer side surface 2252 of the projection portion 2125 having an annular shape and the outer peripheral surface 2123 of the lens 212 was 0.1 mm was prepared. The optical unit 2100X was manufactured in substantially the same conditions as in Example 8 except these.

The change in the fixed position of Comparative Example 3 was 22 and therefore the evaluation result was “B”. In Comparative Example 3, the projection portion 2125 was close to the outer peripheral surface 2123 of the lens 212, and as a result of the adhesive permeating between the projection portion 2125 and the main surface 2111 and contacting the projection portion 2125, the bonding portions 2131X were formed. It can be considered that, as a result of this, in Comparative Example 3, interface delamination of the bonding portion 2131X occurred, and thus the change in the fixed position increased as compared with Example 8.

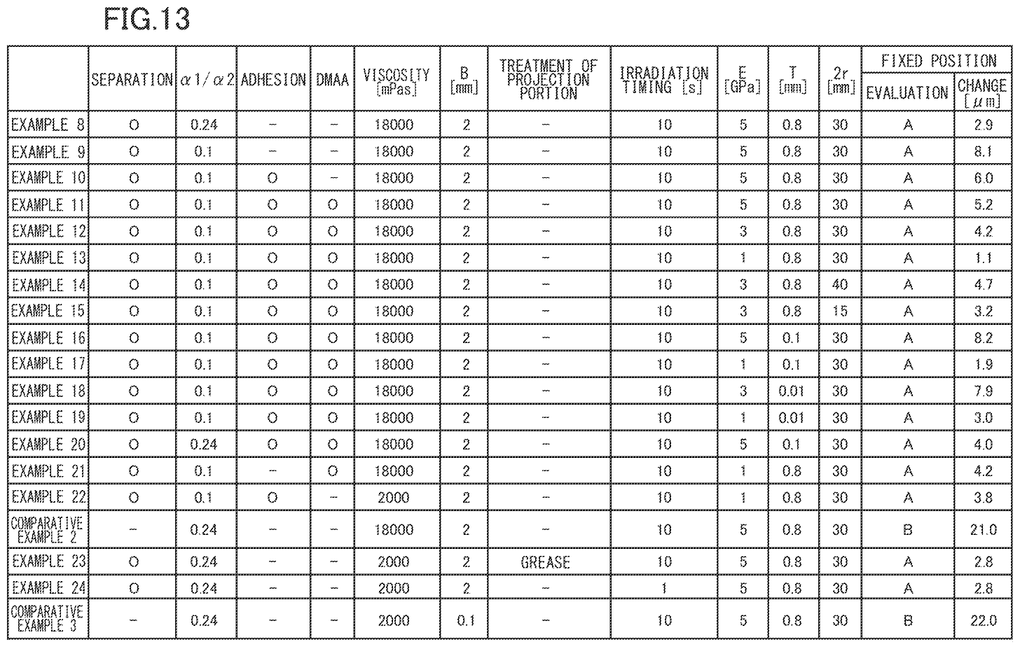

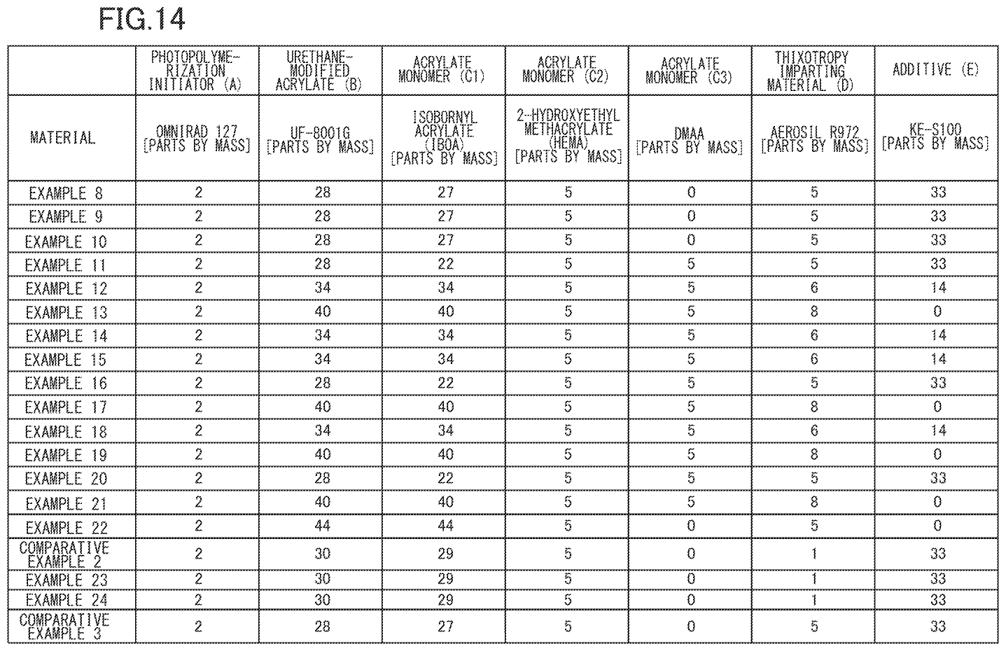

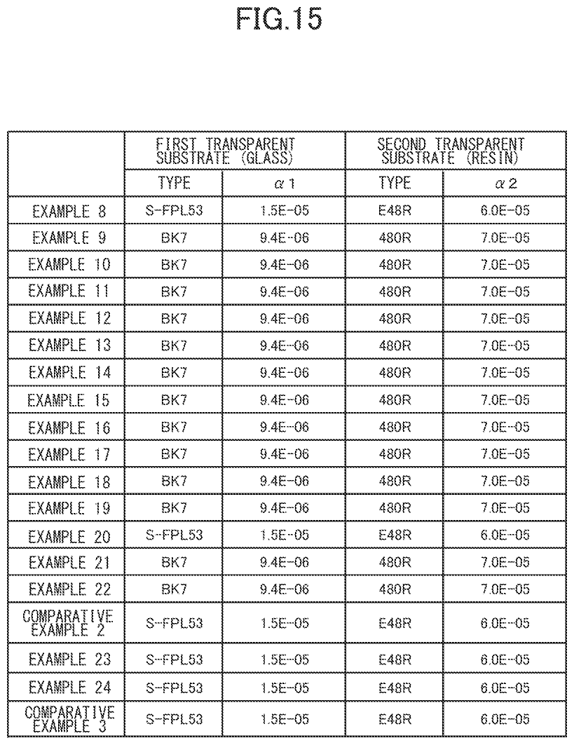

Tables of FIGS. 13 to 15 show conditions and results of Examples 8 to 24 and Comparative Examples 2 and 3 described above. In FIG. 13, “Separation” indicates whether or not the bonding members 213 or 213X are separate from the projection portion 2125, where “O” indicates that there is a separation, and “-” indicates that there is no separation. “Adhesion” indicates whether or not the bonding members 213 or 213X are in contact with the outer peripheral surface 2123 of the lens 212, where “O” indicates that there is contact, and “-” indicates that there is no contact. “DMAA” indicates whether or not the bonding members 213 or 213X contain DMAA, where “O” indicates that DMAA is contained, and “-” indicates that DMAA is not contained. “Viscosity” indicates the viscosity of the uncured adhesive. “B” indicates the distance in the radial direction R1 between the outer peripheral surface 2123 of the lens 212 and the outer side surface 2252 of the projection portion 2125. “Treatment of Projection Portion” indicates whether or not the grease is applied on the projection portion 2125, where “Greased” indicates that grease is applied, and “-” indicates that grease is not applied. “Irradiation Timing” indicates how many seconds later ultraviolet light is irradiated from the last application of the adhesive.

From the results described above, in the case where the elastic modulus of the bonding members 213 at the temperature of −30° C. is denoted by E [GPa] and the thickness of the portion of the bonding member 213 between the lenses 211 and 212 is denoted by T [mm], it is preferable that E≤2.3×T+2.5 is satisfied. In addition, it is preferable that E≤2.3×T−0.08×r+2.5 is satisfied.

The present invention is not limited to the embodiments described above, and can be modified in many ways within the technical concept of the present invention. In addition, the effects described in the embodiments are merely enumeration of the most preferable effects that can be obtained from the present disclosure, and the effects of the present invention are not limited to those described in the embodiments.

Although a case where the optical element of the present invention is applied to an image pickup apparatus such as a digital camera and an optical device such as a lens barrel has been described in the embodiments described above, the configuration is not limited to this. For example, the optical element of the present invention can be applied to various image pickup apparatuses and optical devices such as smartphones, tablet PCs, gaming devices, mobile communication devices, wearable devices, and projectors.

In addition, although a case where the substrate 110 is formed of glass and the substrate 120 is formed of resin has been described as a preferable example in the embodiments described above, the materials are not limited to these as long as the linear expansion coefficient of the substrate 110 and the linear expansion coefficient of the substrate 120 are different.

In addition, although a case where the substrate 2110 is formed of glass and the substrate 2120 is formed of resin has been described as a preferable example in the embodiments described above, the materials are not limited to these as long as the linear expansion coefficient of the substrate 2110 and the linear expansion coefficient of the substrate 2120 are different.

According to the present disclosure, relative displacement of the second transparent member with respect to the first transparent member can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-192000, filed Nov. 26, 2021, and Japanese Patent Application No. 2021-192001, filed Nov. 26, 2021, which are hereby incorporated by reference herein in their entirety.

What is claimed is:

1. An optical element comprising:
a first transparent member;
a second transparent member disposed in contact with the first transparent member and having a different linear expansion coefficient from the first transparent member; and
a bonding member configured to bond the first transparent member and the second transparent member to each other,
wherein an elastic modulus of the bonding member is 1700 MPa or less at a temperature of −30° C.

2. The optical element according to claim 1, wherein the elastic modulus of the bonding member is 200 MPa or more at the temperature of −30° C.

3. The optical element according to claim 1, wherein a force required for peeling off the second transparent member from the first transparent member is 40 N or more.

4. The optical element according to claim 1,
wherein the first transparent member includes a first transparent substrate, and
the second transparent member includes a second transparent substrate.

5. The optical element according to claim 4, wherein in a case where a linear expansion coefficient of the first transparent substrate is represented by α1 and a linear expansion coefficient of the second transparent substrate is represented by α2, α1/α2≤0.24 is satisfied.

6. The optical element according to claim 4,
wherein the first transparent substrate is formed of glass, and
the second transparent substrate is formed of resin.

7. The optical element according to claim 6, further comprising a holding member formed of resin and configured to hold the first transparent member.

8. The optical element according to claim 1, wherein the bonding member is a cured product of a cross-linking adhesive.

9. The optical element according to claim 1,
wherein the first transparent member has a first main surface,
the second transparent member has a second main surface facing the first main surface and includes a projection portion projecting with respect to the second main surface,
the projection portion has an end surface that faces the first main surface and is partially in contact with the first main surface, and
at least part of the bonding member is present in a gap between the first main surface and the end surface.

10. The optical element according to claim 9, wherein an average thickness of the at least part of the bonding member present between the first main surface and the end surface is 0.05 mm or less.

11. The optical element according to claim 9, wherein in a case where an elastic modulus of the bonding member at the temperature of −30° C. is represented by E [MPa] and an average thickness of the at least part of the bonding member is represented by T [mm], E≤3.5×10⁴×T−50 is satisfied.

12. The optical element according to claim 9, wherein the bonding member is in contact with the first main surface and the second main surface.

13. The optical element according to claim 9,
wherein the second transparent member has an outer peripheral surface, and
the bonding member is in contact with the outer peripheral surface.

14. The optical element according to claim 9, wherein the second main surface is separated from the first main surface.

15. The optical element according to claim 9, wherein the projection portion is one of a plurality of projection portions arranged at intervals in a peripheral direction.

16. The optical element according to claim 9, wherein the projection portion has an annular shape.

17. The optical element according to claim 1, wherein the bonding member is one of a plurality of bonding members arranged at intervals in a peripheral direction.

18. An optical device comprising:
a casing; and
the optical element according to claim 1 disposed inside the casing.

19. The optical device according to claim 18, wherein the optical device is a lens barrel attachable to and detachable from a body of an image pickup apparatus.

20. An image pickup apparatus comprising:
the optical element according to claim 1; and
an image sensor configured to receive light having passed through the optical element.

21. An optical element comprising:
a first transparent member;
a second transparent member having a different linear expansion coefficient from the first transparent member; and
a bonding member configured to bond the first transparent member and the second transparent member to each other,
wherein the first transparent member has a first main surface,
the second transparent member has a second main surface that is partially in contact with the first main surface, and
the bonding member is separated from a position where the first main surface and the second main surface are in contact with each other.

22. The optical element according to claim 21, wherein the bonding member bonds the first main surface and the second main surface to each other.

23. The optical element according to claim 21,
wherein the second transparent member has an outer peripheral surface, and
the bonding member is in contact with the outer peripheral surface.

24. The optical element according to claim 21,
wherein the first transparent member includes a first transparent substrate, and
the second transparent member includes a second transparent substrate.

25. The optical element according to claim 24, wherein in a case where a linear expansion coefficient of the first transparent substrate is represented by α1 and a linear expansion coefficient of the second transparent substrate is represented by α2, α1/α2≤0.24 is satisfied.

26. The optical element according to claim 21, wherein the bonding member contains N,N-dimethylacrylamide.

27. The optical element according to claim 21, wherein in a case where an elastic modulus of the bonding member at a temperature of −30° C. is represented by E [GPa] and a thickness of part of the bonding member between the first transparent member and the second transparent member is represented by T [mm], E≤2.3×T+2.5 is satisfied.

28. The optical element according to claim 21,
wherein the second transparent member includes a projection portion that is in contact with the first main surface and that projects with respect to the second main surface, and
the bonding member is separated from the projection portion.

29. The optical element according to claim 28, wherein in a case where an elastic modulus of the bonding member at a temperature of −30° C. is represented by E [GPa], a thickness of part of the bonding member between the first transparent member and the second transparent member is represented by T [mm], and a distance between a center axis of the second main surface and the projection portion in a radial direction is represented by r [mm], E≤2.3×T−0.08×r+2.5 is satisfied.

30. An optical device comprising:
a casing; and
the optical element according to claim 21 disposed inside the casing.

31. The optical device according to claim 30, wherein the optical device is a lens barrel attachable to and detachable from a body of an image pickup apparatus.

32. An image pickup apparatus comprising:
the optical element according to claim 21; and
an image sensor configured to receive light having passed through the optical element.
